(19) United States
(12) Patent Application Publication
(10) Pub. No.: US 2008/0112644 A1
(43) Pub. Date: May 15, 2008

(54) IMAGING DEVICE

(75) Inventors: Masahiro YOKOHATA, Osaka City (JP); Yasuhachi Hamamoto, Moriguchi City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 11/936,154

(22) Filed: Nov. 7, 2007

(30) Foreign Application Priority Data
Nov. 9, 2006 (JP) JP2006-303961

(51) Int. Cl. G06K 9/64

(52) U.S. Cl. 382/278

(57) ABSTRACT

N separately-exposed images are serially captured in an additive-type image stabilization processing that generates one synthetic image having reduced influence due to camera shake by positioning and additively synthesizing a plurality of separately-exposed images. For each non-reference image (Iₙ), the strength (the degree of similarity) of a correlation between a reference image (Iₒ) and each of the non-reference images is evaluated. Each of the non-reference image is determined whether valid or not according to the strength of each correlation. By using the reference image and valid ones of the non-reference images, a synthetic image is generated by additive synthesis.

### CROSS REFERENCE TO RELATED APPLICATIONS

This application claims priority based on 35 USC 119 from prior Japanese Patent Application No. P2006-303961 filed on Nov. 9, 2006, the entire contents of which are incorporated herein by reference.

### BACKGROUND OF THE INVENTION

1. Field of the Invention

The invention relates to imaging devices such as digital still cameras and digital video cameras. The invention relates more particularly to additive-type image stabilization techniques.

2. Description of Related Art

Obtaining a sufficiently bright image, though shot in a dark place, requires a larger aperture and longer exposure times. Longer exposure, however, results in a larger so-called camera shake, which takes place when the camera moves at the time of photographing. This camera shake makes the image blurred. In order to suppress camera shake, a shorter exposure time is effective. However, the amount of light that can be secured with such shorter exposure is not enough for photography in a dark place.

Additive-type image stabilization is a method proposed for obtaining a sufficient amount of light while photographing in a dark place with short exposure. In additive-type image stabilization, the ordinary exposure time t1 is divided into a plurality of shorter pieces of exposure time t2, and separately-exposed images (short time exposure images) G1 to G4, each with exposure time t2, are serially captured. Thereafter, the separately-exposed images G1 to G4 are positioned so that motions between the separately-exposed images are cancelled, and then the separately-exposed images G1 to G4 are additively synthesized. Thus, a synthetic image that is less affected by camera shake can be generated with a desired brightness (refer to FIG. 17).

Incidentally, in a technique disclosed in Japanese Patent Application Laid-Open Publication No. 2006-33232, a still image with high resolution is generated via use of a plurality of continuous frames forming a moving image.

Conventional additive-type image stabilization, however has a problem. The quality of a synthetic image deteriorates with radical changes in shooting conditions during the serial capture of separately-exposed images. For example, with a flash from another camera in the exposure time for a separately-exposed image G2, the brightness of the separately-exposed image G2 greatly differs from that of the other separately-exposed images as shown in FIG. 18. As a result, the accuracy of positioning the separately-exposed image G2 with the other separately-exposed images decreases, and accordingly, the quality of the synthetic image deteriorates.

Incidentally, Japanese Patent Application Laid-Open Publication No. 2006-33232 describes a technique for generating still images with high resolution by using a moving image. However, this technique does not use additive-type image stabilization to solve the above-described problems.

Accordingly, an object of the invention is to provide an imaging device that enhances quality of a synthetic image generated by employing additive-type image stabilization processing and the like.

### SUMMARY OF THE INVENTION

In view of the above-described object, an aspect of the invention provides an imaging device, which includes: an imaging unit for sequentially capturing a plurality of separately-exposed images; and a synthetic-image generating unit for generating one synthetic image from the plurality of separately-exposed images. Here, the synthetic-image generating unit includes: a correlation evaluating unit for judging whether or not each non-reference image is valid according to the strength of a correlation between a reference image and each of the non-reference images, where any one of the plurality of separately images is specified as the reference image while the other separately-exposed images are specified as non-reference images; and the image synthesizing unit for generating the synthetic image by additively synthesizing at least a part of a plurality of candidate images for synthesis including the reference image and a valid non-reference image.

Thus, for example, additive synthesis can be performed without including a non-reference image that weakly correlates with a reference image, and which thus causes image deterioration of a synthetic image when used as a target image for additive synthesis.

More specifically, for example, when the number of candidate images for synthesis is equal to or greater than a predetermined required number of images for addition, the image synthesizing unit sets, from among the plurality of candidate images for synthesis, candidate images for synthesis of the required number of images for addition respectively as images for synthesis, and further performs additive synthesis on the images for synthesis to thereby generate the synthetic image.

Further, more specifically, for example, when the number of candidate images for synthesis is less than a predetermined number of images for addition, the synthetic-image generating unit generates duplicate images of any one of the candidate images for synthesis so as to increase the total number of the plurality of candidate images and the duplicate images up to the required number of images for addition; and the image synthesizing unit respectively sets the plurality of candidate images and the duplicate images as images for synthesis, and generates the synthetic image by additively synthesizing the images for synthesis.

Alternatively, for example, when the number of the candidate images for synthesis is less than a predetermined number of images for addition, the image synthesizing unit performs a brightness correction on an image obtained by additively synthesizing the plurality of candidate images for synthesis. The brightness correction is performed according to a ratio of the number of candidate images for synthesis and the required number of images for addition.

Thus, even when the number of candidate images for synthesis is less than the required number of images for addition, a synthetic image having desired brightness can be generated.

Still further, for example, the imaging unit sequentially captures separately-exposed images as a plurality of separately-exposed images in excess of a predetermined required number of images for addition in order to generate the synthetic image.

Alternatively, for example, the number of separately-exposed images may be varied according to results from determining whether each of the non-reference images is valid or invalid so that the number of candidate images for synthesis attains a predetermined required number of images for addition.

Thus, it is possible to secure the essentially required number of candidate images for synthesis.

More specifically, for example, the correlation evaluating unit calculates, for each division exposure image, an evaluation value based on a luminance signal or a color signal, and evaluates the strength of the correlation by comparing the evaluation value for each of the reference images, thereby judging whether each of the non-reference images is valid or not according to the result of the evaluation.

Here, the color signals are, for example, R, G, and B signals.

Further, specifically, for example, the imaging unit includes: an imaging element having a plurality of light-receiving picture elements; and a plurality of color filters respectively allowing lights of specific colors to pass through. Each of the plurality of light-receiving picture elements is provided with a color filter of any one of the colors, and each of the separately-exposed images is represented by output signals from the plurality of light-receiving picture elements. The correlation evaluating unit calculates, for each of the separately-exposed images, an evaluation value based on output signals from the light-receiving picture elements that are provided with the color filters of the same color, and evaluates the strength of the correlation by comparing the evaluation value for the reference image and the evaluation value for each of the non-reference images, thereby judging whether each of the non-reference images is valid or not according to the evaluation result.

In an embodiment, the imaging device further includes a motion vector calculating unit for calculating a motion vector representing motion of an image between the separately-exposed images according to output signals of the imaging unit. In the imaging device, the correlation evaluating unit evaluates the strength of the correlation according to the motion vector, and judges whether each of the non-reference images is valid according to the evaluation result.

According to the invention, it is possible to enhance image quality of a synthetic image that is generated by employing an additive-type image stabilization processing and the like.

### BRIEF DESCRIPTION OF THE DRAWINGS

FIG. 1 is a block diagram showing an imaging device according to an embodiment of the invention.

FIG. 2 shows an internal configuration of an imaging unit of FIG. 1.

FIG. 3 is a functional block diagram of an image stabilization processing unit included in the imaging device of FIG. 1.

FIG. 4 shows motion detection regions within a separately-exposed image defined by a motion detecting unit of FIG. 3.

FIGS. 5A and 5B are conceptual diagrams showing a first processing procedure according to a first embodiment of the invention.

FIG. 6 is an operation flowchart of an additive-type image stabilization processing according to the first embodiment of the invention.

Fig. shows an original image for calculating entire motion vectors to be referred by a displacement correcting unit of FIG. 3.

FIG. 8 shows a variation of the operation flowchart of FIG. 6.

FIG. 9 is a conceptual diagram of a second processing procedure according to a second embodiment of the invention.

FIGS. 10A and 10B are alternate views of variations of the second processing procedure in corresponding FIG. 9.

FIG. 11 shows a state in which a correlation evaluation region is defined within each separately-exposed image, according to a third embodiment of the invention.

FIG. 12 shows a state in which a plurality of correlation evaluation regions are defined within each separately-exposed image, according to the third embodiment of the invention.

FIGS. 13A and 13B are views for describing a seventh evaluation method according to the third embodiment of the invention.

FIGS. 14A and 14B are views for describing the seventh evaluation method according to the third embodiment of the invention.

FIG. 15 illustrates a ninth evaluation method according to the third embodiment of the invention.

FIGS. 16A and 16B are views of an influence of a flash by another camera on each separately-exposed image, according to a fourth embodiment of the invention.

FIG. 17 is a view for describing a conventional additive-type image stabilization.

FIG. 18 is a view for describing a problem that resides in a conventional additive-type image stabilization.

### DETAILED DESCRIPTION OF THE PREFERRED EMBODIMENTS

Embodiments of the invention are described below with reference to the accompanying drawings. In the following drawings, the same reference numerals and symbols are used to designate the same components, and so repetition of the description on the same or similar components will be omitted. Common subject matters in the respective embodiments and points to be referred in the respective embodiments will be first described while first to fourth embodiments are described later.

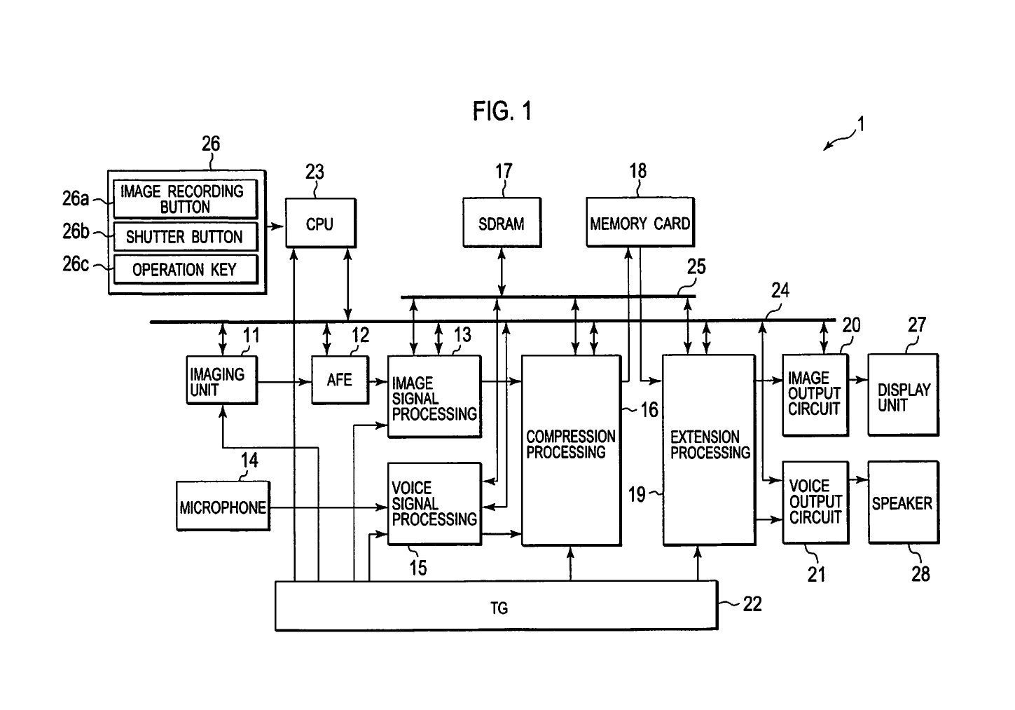

FIG. 1 is a block diagram showing an entire imaging device 1 of embodiments of the invention. The imaging device 1 is a digital video camera that is capable of shooting moving and still images. Alternatively, imaging device 1 may be a digital still camera that is capable of shooting still images only.

The imaging device 1 includes an imaging unit 11, an AFE (Analog Front End) 12, an image signal processing unit 13, a microphone 14, a voice signal processing unit 15, a compression processing unit 16, an Synchronous Dynamic Random Access Memory (SDRAM) 17 as an example of an internal memory, a memory card (a storing unit) 18, an expansion processing unit 19, an image output circuit 20, a voice output circuit 21, a Timing Generator (TG) 22, a Central Processing Unit (CPU) 23, a bus 24, a bus 25, an operation unit 26, a display unit 27, and a speaker 28. The operation unit 26 has an image recording button 26a, a shutter button 26b, an operation key 26c, and the like. The respective units of the imaging unit 1 perform transmission and receipt of signals (data) between the respective units through the buses 24 and 25.

First, basic functions of the imaging device 1 and the respective units configuring the imaging device 1 will be described. TG 22 generates a timing control signal for controlling timings of each operation in the entire imaging device 1, and provides the generated timing control signal to the respective units of the imaging device 1. More specifically, the timing control signal is provided to the imaging unit 11, the image signal processing unit 13, the voice signal processing unit 15, the compression processing unit 16, the expansion processing unit 19, and the CPU 23. A timing control signal includes a vertical synchronizing signal Vsync and a horizontal synchronizing signal Hsync.

The CPU 23 controls the overall operations of the respective units of the imaging device 1, and the operation unit 26 receives an operation by a user. Operation content given to the operation unit 26 is transmitted to the CPU 23. The SDRAM 17 serves as a frame memory. At the time of signal processing, the respective units of the imaging device 1 temporarily store various data (digital signals) in the SDRAM 17 as needed.

The memory card 18 is an external recording medium, for example, a Secure Digital (SD) memory card. In this embodiment, memory card 18 exemplifies an external recording medium. However, the external recording medium can be configured by a single recoding medium or a plurality of recording media such as a semiconductor memory, a memory card, an optical disk, or a magnetic disk, with each allowing random accesses.

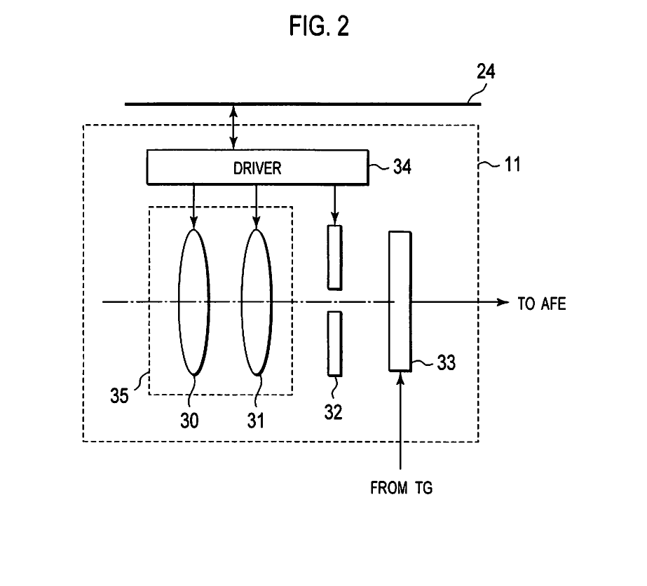

FIG. 2 is a view of an internal configuration of the imaging unit 11 of FIG. 1. By using a color film and the like for the imaging unit 11, the imaging unit 1 is configured so that the imaging device 1 can generate a color image through shooting.

The imaging unit 11 has an optical system 35, an aperture 32, an imaging element 33, and a driver 34. The optical system 35 is configured with a plurality of lenses including a zoom lens 30 and a focus lens 31. The zoom lens 30 and the focus lens 31 are capable of moving in the direction of an optical axis. The driver 34 controls the movement of the zoom lens 30 and the focus lens 31 according to control signals from the CPU 23, thereby controlling the zoom factor and the focal length of the optical system 35. In addition, the driver 34 controls the degree of opening (the size of the opening) of the aperture 32 according to a control signal from the CPU 23.

Incident light from a subject enters imaging element 33 through the respective lenses constituting the optical system 35, and the aperture 32. The respective lenses constituting the optical system 35 form an optical image of the subject on the imaging element 33. The TG 22 generates a drive pulse for driving the imaging element 33, which is synchronized with the above-described timing control signal, and thereby, the drive pulse is given to the imaging device 33.

The imaging element 33 includes, for example, a charge coupled device (CCD) image sensor, a complementary metal oxide semiconductor (CMOS) image sensor, and the like. The imaging element 33 photoelectrically converts an optical image entered through the optical system 35 and the aperture 32, and then outputs, to the AFE 12, an electric signal obtained through the photoelectric conversion. To be more specific, the imaging unit 33 includes a plurality of picture elements (light receiving picture elements, not shown) that are two-dimensionally arranged in matrix, and each picture element stores, in each shooting, a signal charge having the quantity of electric charge corresponding to an exposure time. An electric signal from each picture element, which has the size proportional to the quantity of electric charge of the stored signal charge, is sequentially output to the AFE 12 in a subsequent stage according to a drive pulse from the TG 22. When optical images that enter the optical system 35 are the same, and when the degrees of openings of the aperture 32 are the same, the magnitudes (intensities) of electric signals from the imaging element 33 (the respective picture elements) increase in proportion to the above-described exposure time.

The AFE 12 amplifies an analogue signal outputted from the imaging unit 11 (the imaging element 33), and then converts the amplified analogue signal into a digital signal. The AFE 12 sequentially outputs this digital signal to the image signal processing unit 13.

By using an output signal from the AFE 12, the image signal processing unit 13 generates an image signal representing an image (hereinafter, referred to as a “captured image”) which is captured by the imaging unit 11. The image signal is composed of a luminance signal Y, which indicates the luminance of a captured image, and color difference signals U and V, which indicate colors of a captured image. The image signal generated in the image signal processing unit 13 is transmitted to the compression processing unit 16 and the image output circuit 20.

Incidentally, the image signal processing unit 13 detects an AF evaluation value, which corresponds to the quantity of contrast within a focus detection region in a captured image, and also an AE evaluation value, which corresponds to the brightness of a captured image, and then transmits the values thus detected to the CPU 23. The CPU 23 adjusts, according to the AF evaluation value, the position of the focus lens 31 via the driver 34 of FIG. 2 in order to form an optical image of a subject on the imaging element 33. In addition, the CPU 23 adjusts, according to the AE evaluation value, the degree of opening of the aperture 32 (and the degree of amplification of signal amplification in the AFE 12, when needed) via the driver 34 of FIG. 2 in order to control the quantity of receiving light.

In FIG. 1, the microphone 14 converts an externally given voice (sound) into an analogue electric signal, thereafter outputting the signal. The voice signal processing unit 15 converts an electric signal (a voice analogue signal) outputted from the microphone 14 into a digital signal. The digital signal obtained by this conversion is transmitted, as a voice signal representing a voice inputted to the microphone 14, to the compression processing unit 16.

The compression processing unit 16 compresses the image signal from the image signal processing unit 13 by using a predetermined compression method. At the time of shooting a moving image or a still image, the compressed image signal is transmitted to the memory card 18, and then is recorded on the memory card 18. In addition, the compression processing unit 16 compresses a voice signal from the voice signal processing unit 15 by a predetermined compression method. At the time of shooting a moving image, an image signal from the image signal processing unit 13 and a voice signal from the voice signal processing unit 15 are compressed in the compression processing unit 16 while time associated with each other, whereafter the image signal and the voice signal thus compressed are recorded on the memory card 18.

Operation modes of the imaging device 1 include a capturing mode in which a still image or a moving image can be captured, and a playing mode in which a moving image or a still image stored in the memory card 18 is played so as to be displayed on the display unit 27. Transition from one mode to the other mode is performed in response to an operation by operation key 26c. In accordance with manipulation of the image recording button 26a, the capturing of a moving image is started or terminated. Further, the capturing of a still image is performed according to operation of the shutter button 26b.

In the playing mode, when a user performs a predetermined operation on the operation key 26c, the compressed image signal, which represents a moving image or a still image, and which is recorded on the memory card 18, is transmitted to the expansion processing unit 19. The expansion processing unit 19 expands the received image signal, and then transmits the expanded image signal to the image outputting circuit 20. In the capturing mode, an image signal is sequentially generated by the image signal processing unit 13 irrespective of whether or not a moving image or a still image is being captured, and the image signal is then transmitted to the image outputting circuit 20.

The image outputting circuit 20 converts the given digital image signal into an image signal in a format which makes it possible for the image signal to be displayed on the display unit 27 (for example, analogue image signal), and then outputs the converted image signal on the display unit 27. The display unit 27 is a display device, such as a liquid crystal display, and displays an image according to an image signal outputted from the image outputting circuit 20.

When a moving image is played in the playing mode, a compressed voice signal recorded on the memory card is also transmitted to the expansion processing unit 19, the compressed voice signal being corresponding to the moving image. The expansion processing unit 19 expands the received voice signal, and then transmits the expanded voice signal to the voice output unit 21. The voice output unit 21 converts the given digital voice signal into a voice signal in a format that makes it possible for the voice signal to be outputted through the speaker 28 (for example, an analogue voice signal), and then outputs the converted voice signal to the speaker 28. The speaker 28 outputs, as a voice (sound), the voice signal from the voice output unit 21 to the outside.

As a characteristic function, the imaging device 1 is configured to achieve additive-type image stabilization processing. In the additive type image stabilization processing, a plurality of separately-exposed images are serially shot, and the respective separately-exposed images are positioned and then additively synthesized, so that one synthetic image, on which an influence of camera shake is checked, is generated. The synthetic image thus generated is stored in the memory card 18.

Here, the exposure time for acquiring an image having a desired brightness by a single exposure is designated by T1. When performing the additive-type image stabilization processing, the exposure time T1 is divided into M time periods. Here, M is a positive integer, and is 2 or larger. Serial capturing is performed during exposure time T2 (=T1/M) obtained by dividing the exposure time T1 by M. A captured image obtained by performing shooting for the exposure time T2 is referred to as a “separately-exposed image.” The respective separately-exposed images are acquired by shooting for the exposure time T2 (=T1/M), which is a time obtained by dividing, by M, the exposure time T1 required for acquiring an image having a desired brightness. Hence, M represents the number of images required for acquiring one synthetic image having a desired brightness by additive synthesis. In light of this, M can be referred to as a required number of images for addition.

The exposure time T2 is set according to the focal length of the optical system 35 so that influence of camera shake in each separately-exposed image can be disregarded. Further, a required number M of images for addition is determined by using the exposure time T2 thus set, and the exposure time T1 set according to the AE evaluation value and the like so that an image having a desired brightness can be acquired.

In general, in the case of obtaining a single synthetic image by additive synthesis, only M separately-exposed images are serially shot. However, in imaging device 1, N separately-exposed images are serially shot. N is a positive integer equal to or larger than M. M separately-exposed images are additively synthesized among the N separately-exposed images, and thereby one synthetic image is generated. In some cases, it may be possible to generate one synthetic image by additively synthesizing separately-exposed images, the number of which is less than M. A description will be given of this later.

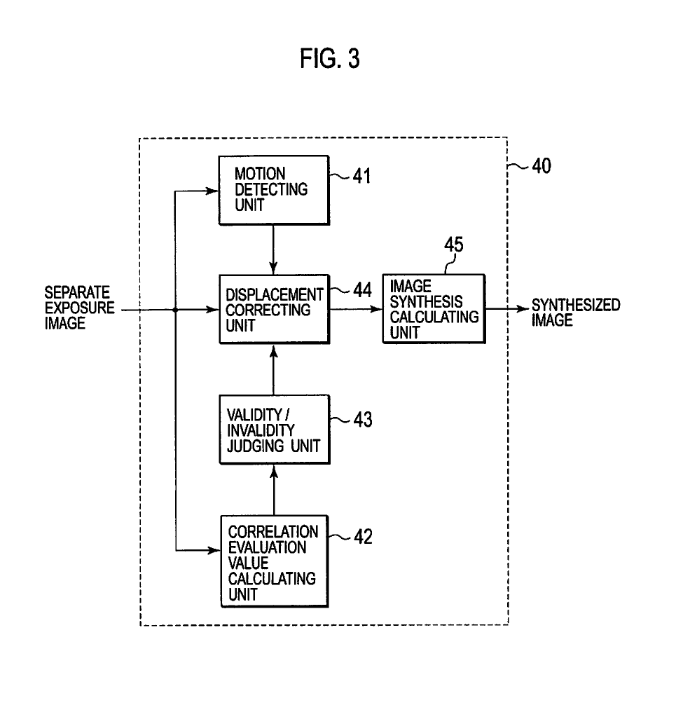

FIG. 3 is a functional block diagram of an image stabilization processing unit (a synthetic-image generating unit) 40 for performing an additive-type image stabilization processing. The image stabilization processing unit 40 includes a motion detecting unit 41, a correlation-evaluation-value calculating unit 42, a validity/invalidity judging unit 43 (hereinafter, referred to simply as a “judging unit 43”), a displacement correction unit 44, and an image synthesis calculating unit 45. While the image stabilization processing unit 40 is formed mainly of the image signal processing unit 13 of FIG. 1, functions of other units (for example, CPU 23 and/or SDRAM 17) of the imaging unit 1 can also be used to form the above.

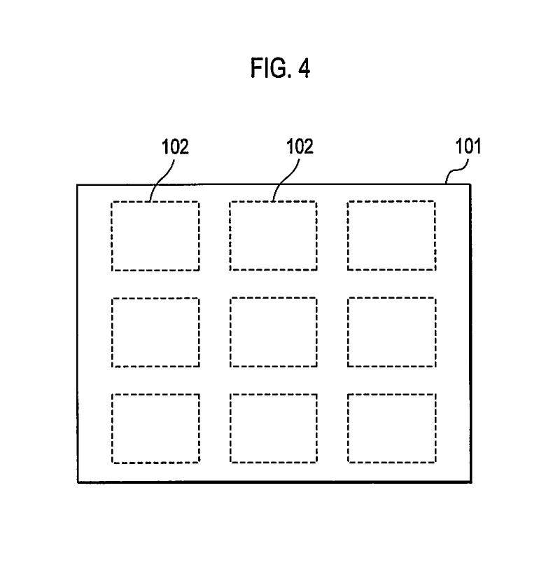

A function of the motion detecting unit 41 is described with reference to FIG. 4. In FIG. 4, reference numeral 101 represents one separately-exposed image, and reference numerals 102 represent a plurality of motion detection regions defined in the separately-exposed image. By using a known image matching method (such as block matching method or representative point matching method), the motion detecting unit 41 calculates, for each motion detection region, a motion vector between two designated separately-exposed images. A motion vector calculated for a motion detection region is referred to as a region motion vector. A region motion vector for a motion detection region specifies the magnitude and direction of a motion of the image within the motion detection region in two compared separately-exposed images.

Further, the motion detecting unit 41 calculates, as an entire motion vector, an average vector of region motion vectors for the number of motion detection regions. This entire motion vector specifies the magnitude and direction of the entire image between two compared separately-exposed images. Alternatively, a reliability of a motion vector may be evaluated for each region motion vector for removing region motion vectors with low reliability, and thereafter, an entire motion vector may be calculated.

Functions of the correlation-evaluation-value calculating unit 42, the judging unit 43 the displacement correction unit 44, and the image synthesis calculating unit 45 will be described in respective embodiments.

Embodiments for specifically describing the additive-type image stabilization processing will be described below. Any description included in an embodiment is also applicable to other embodiments, as long as no contradiction occurs.

### First Embodiment

In the first embodiment, N is a positive integer greater than a positive integer M. For example, the value of N is a value obtained by adding a predetermined natural number to M.

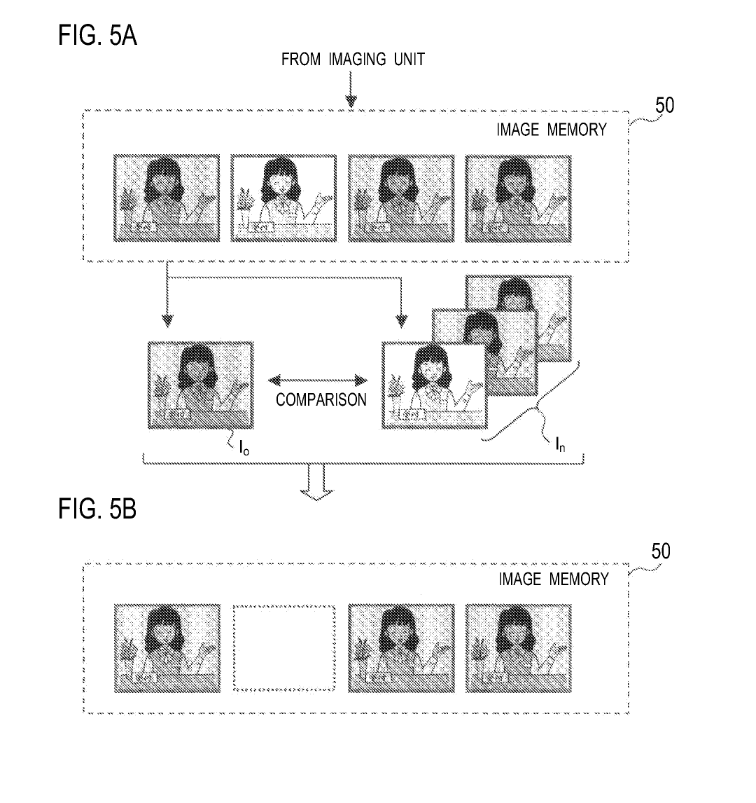

In the first embodiment, a first processing procedure is adopted as a processing procedure for an additive synthesis. FIGS. 5A and 5B are conceptual diagrams of the first processing procedure. In the first embodiment, all of N separately-exposed images acquired by serial capturing are temporarily stored in an image memory 50 as shown in FIG. 5A. For this image memory 50, the SDRAM 17 of FIG. 1 is used, for example.

Further, among the N separately-exposed images, one of the N separately-exposed images is determined to be a reference image Iₒ, and (N−1) separately-exposed images other than the reference image are set as non-reference images Iₙ (n=1, 2, . . . , (N−1)). A way of determining which separately-exposed image will become the reference image Iₒ will be described later. Hereinafter, for the sake of simplifying descriptions, the reference image is simply designated as Iₒ, and the non-reference image Iₙ is simply designated as Iₙ, in some cases. In addition, in some cases, the symbol Iₒ or Iₙ may be omitted.

The correlation-evaluation-value calculating unit 42 of FIG. 3 calculates a correlation evaluation value for each non-reference image by reading a reference image from the image memory 50 and also sequentially reading the non-reference images, the correlation evaluation value being for evaluating the strength (in other words, the degree of similarity) of a correlation between the reference image and each of the non-reference images. In addition, the correlation-evaluation-value calculating unit 42 also calculates a correlation evaluation value with respect to the reference image. By using the correlation evaluation values, the judging unit 43 of FIG. 3 judges the strength of a correlation between the reference image and each of the non-reference images, and then deletes, from the image memory 50, non-reference images that have determined weak correlation with the reference image. FIG. 5B schematically represents stored contents of the image memory 50 after the deletion. Thereafter, the respective images in the image memory 50 are positioned by the displacement correction unit 44, and are thereafter additively synthesized by the image synthesis calculating unit 45.

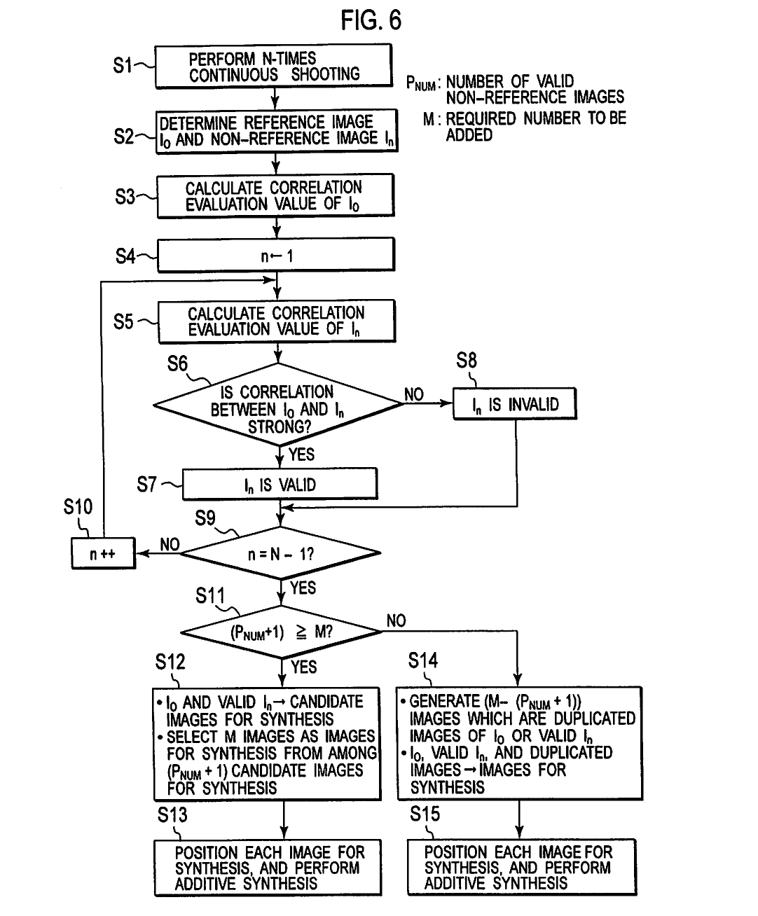

### (FIG. 6; Operation Flow)

Operation of the additive-type image stabilization processing of the first embodiment will be described with reference to FIG. 6. FIG. 6 is a flowchart representing a procedure of this operation.

In response to a predetermined operation to the operation unit 26 (refer to FIG. 1), in Step S1, the imaging unit 11 sequentially captures N separately-exposed images. Subsequently, in Step S2, the image stabilization processing unit 40 determines one reference image Iₒ, and (N−1) non-reference images Iₙ. n takes one of the values, 1, 2, . . . , and (N−1).

Next, in Step S3, the correlation-evaluation-value calculating unit 42 of FIG. 3 calculates a correlation evaluation value on the reference image Iₒ. A correlation evaluation value of a separately-exposed image represents an aspect of the separately-exposed image, for example, an average luminance of the entire image. A calculation method of a correlation evaluation value will be described in detail in another embodiment.

Subsequently, in Step S4, the value 1 is substituted for a variable n, and then, the processing moves to Step S5. In Step S5, the correlation-evaluation-value calculating unit 42 calculates a correlation evaluation value on the non-reference image Iₙ. For example, when the variable n is 1, a correlation evaluation value with respect to I₁ is calculated; and when the variable n is 2, a correlation evaluation value with respect to I₂ is calculated. The same applies to the case where the variable n is a value other than 1 and 2.

In Step S6 subsequent to Step S5, the judging unit 43 compares the correlation evaluation value with respect to the reference image Iₒ, which is calculated in Step S3, and the correlation evaluation value with respect to the non-reference image Iₙ, which is calculated in Step S5, whereby the judging unit 43 evaluates the strength of a correlation between the reference image Iₒ and the non-reference image Iₙ. For example, when the variable n is 1, the strength of a correlation between Iₒ and I₁ is evaluated by comparing the correlation evaluation values on Iₒ and I₁. The same applies to the case where the variable n is a value other than 1.

When it is determined that Iₙ has a comparatively strong correlation with Iₒ (Yes in Step S6), the processing moves to Step S7, and the judging unit 43 determines that Iₙ is valid. Meanwhile, when it is determined that Iₙ has a comparatively weak correlation with I_{c} (No in Step S6), the processing moves to Step S8, and the judging unit 43 determines that Iₙ is invalid. For example, when the variable n is 1, whether I₁ is valid or not is determined according to the strength of a correlation between Iₒ and I₁.

The strength of a correlation between the reference image Iₒ and the non-reference image Iₙ represents the degree of similarity between the reference image Iₒ and the non-reference image Iₙ. When the strength of the correlation between the reference image Iₒ and the non-reference image Iₙ is comparatively high, the degree of similarity therebetween is comparatively high, while when the strength of the correlation is comparatively low, the degree of similarity is comparatively low. When a reference image and a non-reference image are exactly the same, correlation evaluation values on both images, which respectively represent aspects of the both images, agree completely with each other, and a correlation between the both images takes a maximum value.

After terminating processing in Steps S7 and S8, the processing moves to Step S9. In Step S9, it is judged whether the variable n agrees with (N−1), and when it agrees, the processing moves to Step S11. Meanwhile, when it does not agree, 1 is added to the variable n in Step S10, thereafter the processing returns to Step S5, and the processing of the above-described Steps S5 to S8 are repeated. Thus, for every non-reference image, the strength of the correlation between the reference image and the non-reference image is evaluated, and it is then determined whether each non-reference image is valid or not according to the evaluated strength of each correlation.

In Step S11, it is determined whether the number of candidate images for synthesis is equal to or larger than the required number M of images for addition. Candidate images for synthesis are candidates of an image for synthesis, which is a target image for additive synthesis. The reference image Iₒ and the respective valid non-reference images (non-reference images which are judged to be valid in Step S7) Iₙ are considered as candidate images for synthesis, while invalid non-reference images (non-reference images which are judged to be invalid in Step S8) Iₙ are not considered as candidate images for synthesis. Accordingly, when the number of valid non-reference images Iₙ is designated by P_{NUM}, it is determined, in Step S11, whether the inequality “(P_{NUM}+1)≧M” holds. When this inequality holds, the processing moves to Step S12.

As described above, Iₒ and the respective valid Iₙ are considered as candidate images for synthesis. In Step S12, the image stabilization processing unit 40 selects, from among (P_{NUM}+1) candidate images for synthesis, M candidate images for synthesis as M images for synthesis.

When (P_{NUM}+1) and M take the same values, the selecting process described above is not necessary, and all candidate images for synthesis are considered to be images for synthesis. When (P_{NUM}+1) is larger than M, the reference image Iₒ is first selected as a candidate image for synthesis, for example. Then, for example, a candidate image for synthesis which has been captured at a timing as close as that of the capturing of the reference image Iₒ, is preferentially selected as an image for synthesis. Alternatively, a candidate image for synthesis which has a strongest correlation with the reference image Iₒ, is preferentially selected as an image for synthesis.

As shown in FIG. 7, the motion detecting unit 41 considers one of the M images for synthesis as a reference image for displacement correction, and also considers the other (M−1) images for synthesis as images to receive displacement correction, thereafter calculating, for each of the images to receive displacement correction, an entire motion vector between a reference image for displacement correction and the image to receive displacement correction. While a reference image for displacement correction typically agrees with the reference image Iₒ, it may agree with an image other than the reference image Iₒ. As an example, it is assumed hereinafter that a reference image for displacement correction agrees with the reference image Iₒ.

In Step S13 following Step S12, in order to eliminate position displacement between the image for synthesis as the reference image for displacement correction (i.e. reference image Iₒ) and each of the other images for synthesis, the displacement correction unit 44 converts the coordinates of each of the images for synthesis into the coordinates of the reference image Iₒ according to the corresponding entire motion vectors thus calculated. More specifically, with the reference image Iₒ set as a reference, positioning of the other (M−1) images for synthesis is performed. Thereafter, the image synthesis calculating unit 45 adds values of the picture elements of the respective images for synthesis in the same coordinate system, the images having had displacement correction, and then stores the addition results in the image memory 50 (refer to FIG. 6). In other words, a synthetic image is stored in the image memory 50, the synthetic image being obtained by performing additive synthesis on the respective picture element values after performing displacement correction between the images for synthesis.

When the inequality “(P_{NUM}+1)≧M” does not hold in Step S11, i.e., when the number (P_{NUM}+1) of a plurality of candidate images for synthesis including the reference image I_{c} and valid non-reference images Iₙ is less than the required number M of images to be added, the processing moves to Step S14. In Step S14, the image stabilization processing unit 40 selects, as an original image for duplication, any one of the reference image Iₒ and the valid non-reference images Iₙ, and generates (M−(P_{NUM}+1)) duplicated images of the original image for duplication. The reference image Iₒ, the valid non-reference images Iₙ, and the duplicated images are set as images for synthesis (M images in total) for acquiring a synthetic image by additive synthesis.

The reference image Iₒ is, for example, set as the original image for duplication. This is because, a duplicated image of the reference image Iₒ has a strongest correlation with the reference image Iₒ, and hence, image deterioration can be reduced to a low degree by additive synthesis.

Alternatively, the original image for duplication may be a valid non-reference image Iₙ which is captured at a closest timing to that of the reference image Iₒ. This is because the shorter the interval between the timings for the above non-reference image and the reference image Iₒ, the smaller the influence by camera shake, and hence, image deterioration can be reduced to a low degree by additive synthesis. Nevertheless, it is still possible to select another arbitrary valid non-reference image Iₙ as an original image for duplication.

After M sheets images for synthesis are determined in Step S14, the processing moves to Step S15. In Step S15, one synthetic image is generated by performing the same processing as that of Step S13.

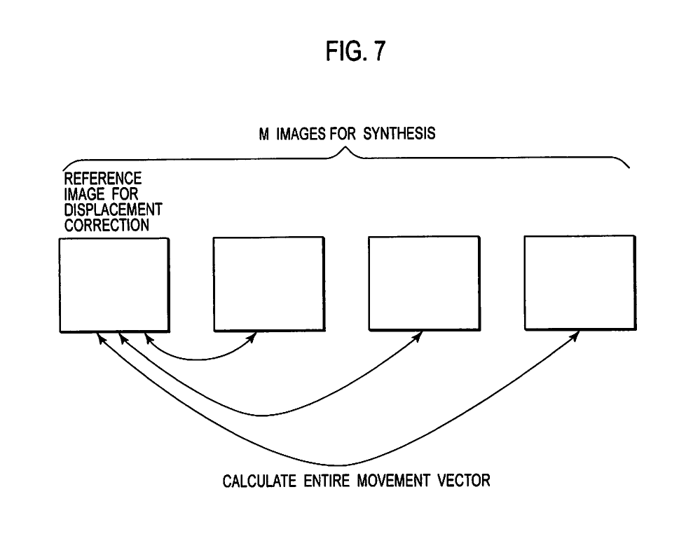

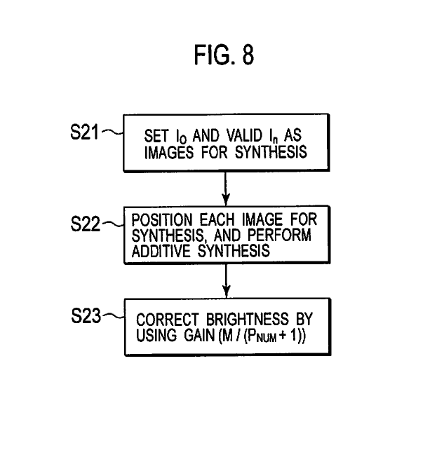

Further, when the inequality “(P_{NUM}+1)≧M” does not hold in Step S11, the processing may move to Step S21 shown in FIG. 8, instead of moving to Step S14. In Step S21, the reference image Iₒ, and the respective valid non-reference images Iₙ are set to be images for synthesis. After Step S21 is terminated, the processing moves to Step S22, and the same processing as that of Step S13 is performed, so that one synthetic image is generated from among (P_{NUM}+1) images for synthesis being less than the required number M of images to be added. A synthetic image generated at this stage is referred to as a first synthetic image.

Since the number (P_{NUM}+1) of images for synthesis is less than the required number M of images for addition, the degree of brightness of the first synthetic image is low. Accordingly, after the processing of Step S22 is terminated, the processing moves to Step S23 where a correction of the degree of brightness is performed on the first synthetic image by using the gain (M/(P_{NUM}+1)). In addition, the correction of the degree of brightness is performed, for example, by a brightness correction unit (not shown) provided on the inside (or the outside) of the image synthesis calculating unit 45.

For example, when the first synthetic image is represented by an image signal in the YUV format, i.e., when the image signal for each picture element of the first synthetic image is represented by a luminance signal Y, and color-difference signals U and V, a brightness correction is performed so that the luminance signal Y of the each picture element of the first synthetic image is multiplied by the gain (M/(P_{NUM}+1)). Thereafter, the image on which the brightness correction has been performed is set to a final synthetic image outputted by the image stabilization processing unit 40. At this time, when only the luminance signal is increased, an observer observing the image feels that the image has become pale in color, and thus it is preferable to increase the color-difference signals U and V of the respective picture elements of the first synthetic image by using the same gain as, or less than, the used gain. Further, for example, when the first synthetic image is represented by an image signal in the RGB format, i.e., when an image signal of each picture element of the first synthetic image is represented by an R signal representing the intensity of a red component, a G signal representing the intensity of a green component, and a B signal representing the intensity of a blue component, brightness correction is performed by multiplying the R signal, the G signal, and the B signal of the each picture element of the first synthetic image by (M/(P_{NUM}+1)), respectively. Thereafter, the image on which the brightness correction has been performed is set to a final synthetic image for output by the image stabilization processing unit 40.

In addition, when the imaging element 33 is of single plate type using a color filter, and when the first synthetic image is represented by an output signal of the AFE 12, a brightness correction is performed so that an output signal of the AFE 12 representing a picture element signal of each picture element of the first synthetic image is multiplied by the gain (M/(P_{NUM}+1). Thereafter, the image on which the brightness correction has been performed is set to a final synthetic image for output by the image stabilization processing unit 40.

According to this embodiment, non-reference images that have a weak correlation with a reference image, and which therefore are not suitable for an additive synthesis, are removed from targets for additive synthesis, so that the image quality of a synthetic image is enhanced (deterioration of image quality is checked). Further, even when the total number of a reference image and valid non-reference images is less than the required number M of images to be added, generation of a synthetic image is secured by performing the above-described duplication processing or brightness correction processing.

When adopting the first processing procedure (referring to FIG. 5), the degree of freedom in selecting a reference image Iₒ is increased while the required storing capacity of image memory 50 is increased relatively. For example, in the case where a first N separately-exposed image which has been captured serially, is constantly set as a reference image Iₒ, it is difficult to obtain a synthetic image of favorable quality when flashes are used by surrounding cameras at the time of capturing a first separately-exposed image.

In the first processing procedure, such a problem can be solved by variably setting a reference image Iₒ. As examples of methods of variably setting a reference image Iₒ, first and second setting examples will be described. In the first setting example, the separately-exposed image of a first shot is temporarily treated as a reference image Iₒ, and processing of Steps S3 to S10 is performed on the separately-exposed image. Thereafter, the number of non-reference images Iₙ which are determined to be invalid is counted. When the number of non-reference images Iₙ having been determined to be invalid is comparatively large, and is more than a predetermined number of images, the processing does not move to Step S11. Instead, the processing of Steps S3 to S10 is again performed after setting a separately-exposed image other than that of the first shot to be a new reference image Iₒ. Thereafter, when the number of non-reference images Iₙ having been determined to be invalid is less than a predetermined number of images, the processing moves to Step S11. In the second setting example, at the time when processing of Step S2 is performed, an average luminance of separately-exposed images is calculate for each separately-exposed image, and further, an average value of the calculated average luminance for the respective separately-exposed images is calculated. Then, a separately-exposed image having an average luminance which is closest to the average value thus calculated is determine to be a reference image Iₒ.

### Second Embodiment

Next, a second embodiment will be described. In the second embodiment, the second processing procedure is adopted as a processing procedure for additive synthesis.

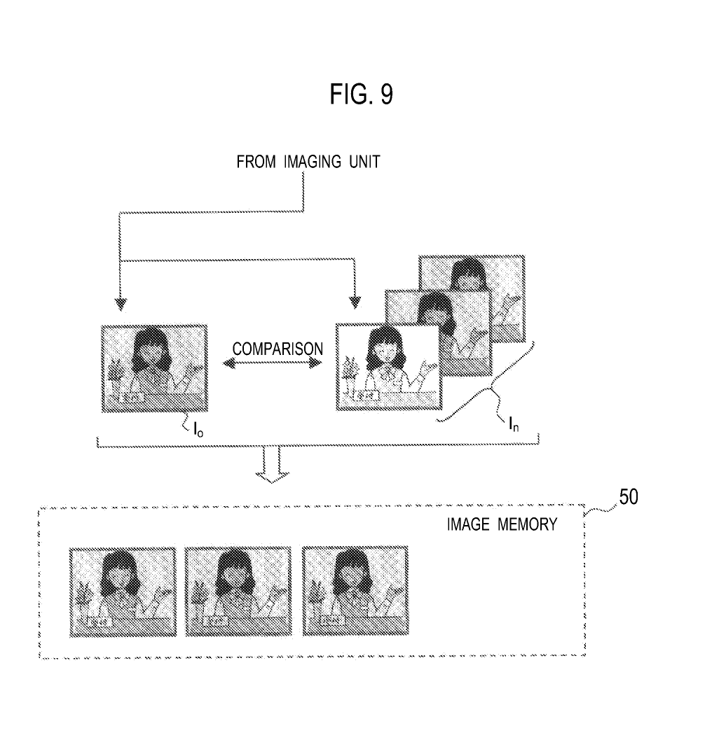

FIG. 9 is a conceptual diagram showing the second processing procedure. In the second processing procedure, among N separately-exposed images which are serially captured, a separately-exposed image which is shot first is set as a reference image Iₒ, and separately-exposed images which are shot subsequent to the first one are set as non-reference images Iₙ. The reference image Iₒ is stored in the image memory 50.

Thereafter, each time when a separately-exposed image is newly captured subsequent to the first shot, the strength of a correlation between one non-reference image Iₙ newly captured and the reference image Iₒ is evaluated, and it is judged whether the one non-reference image Iₙ is valid or invalid. The processing involved in this judgment is the same as that of Step S3, and Steps S5 to S8 (FIG. 6) of the first embodiment. At this time, among a plurality of non-reference images Iₙ which are shot one after another, only those which are judged to be valid are stored in the image memory 50.

When the number of valid non-reference images Iₙ, designated by P_{NUM}, reaches the value obtained by subtracting 1 from the required number M of images to be added, capturing of a new non-reference image Iₙ is terminated. At this time, one reference image Iₒ, and (M−1) valid non-reference image Iₙ have been stored in the image memory 50. When there is no invalid non-reference image Iₙ, the number N of separately-exposed images by serial capturing agrees with a required number M of images to be added.

The displacement correction unit 44 and the image synthesis calculating unit 45 consider the images stored in the image memory 50 as images for synthesis (or candidate images for synthesis), and thereby one synthetic image is generated by positioning and additively synthesizing the respective images for synthesis as in the processing of Step S13.

As described above, in the second processing procedure, since serial capturing can be performed until (M−1) non-reference images, each having a strong correlation with the reference image, are acquired, the problem can be avoided that a required number of images for synthesis cannot be acquired. Further, while the image memory 50 needs to store N separately-exposed images irrespective of the strength of a correlation between the respective separately-exposed images in the first processing procedure, N being larger than M, the image memory 50 needs to store only M separately-exposed images in the second processing procedure. Thus, in comparison to the first processing procedure, only a small storage capacity is necessary for the image memory 50.

In addition, in the above description of the second processing procedure, it has been described that “when the number of valid non-reference images Iₙ, designated by P_{NUM}, attains the value obtained by subtracting 1 from the required number M of images to be added, capturing of a new non-reference image Iₙ is terminated”. This processing corresponds to the processing of variably setting, according to results of judgment as to whether non-reference images Iₙ are valid or invalid, the number N of separately-exposed images to be serially captured so that the number of images for synthesis (candidate images for synthesis) to be used for acquiring a synthetic image attains the required number M of images to be added.

However, the setting of the number N of images to be serially captured can be fixed also in the second processing procedure, as in the case of the first processing procedure of the first embodiment. In this case, as in the case where the first processing procedure is adopted, there are some cases in which the inequality “(P_{NUM}+1)≧M” does not hold after capturing N separately-exposed images. In the case where the inequality “(P_{NUM}+1)≧M” does not hold, it is only necessary to generate a synthetic image through the processing of Steps S14 and S15 of FIG. 6, or the processing of Steps S21 to S23 of FIG. 8, as in the case where the first processing procedure is adopted.

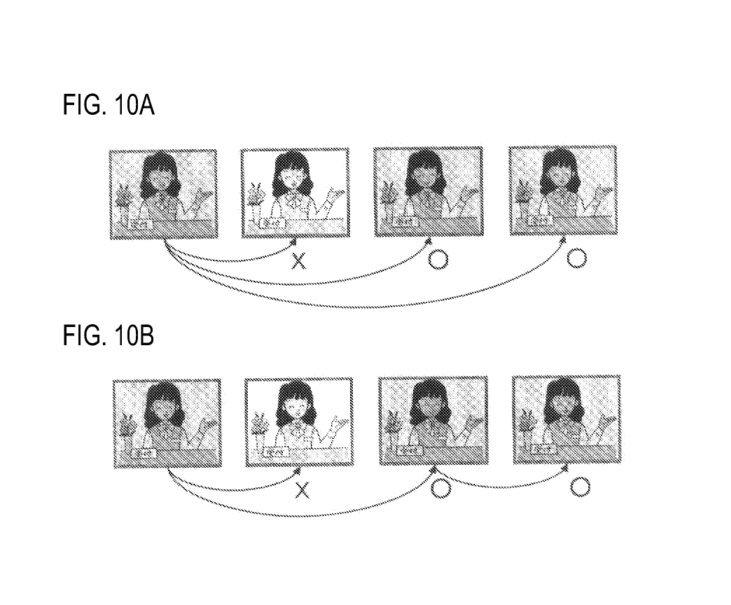

Incidentally, in the second processing procedure, it is possible to change the reference image Iₒ as follows. A variation in which such a change is made is referred to as a varied processing procedure. FIG. 10B shows a conceptual diagram of a varied processing procedure (a method in which an image serving as a reference image Iₒ is changed from one image to another image). To contrast with this procedure, FIG. 10A shows a conceptual diagram of a method in which a separately-exposed image of the first shot is fixedly used as a reference image Iₒ. In each of FIGS. 10A and 10B, a separately exposed image placed at the start point of an arrow correspond to a reference image Iₒ, and a judgment is made, between separately exposed images at the start and end points of an arrow, as to whether the image is valid or invalid.

In the varied processing procedure corresponding to FIG. 10B, first, a separately-exposed image of the first shot is set as a reference image Iₒ. Thereafter, for each time when a separately-exposed image is newly captured subsequent to the first shot, the strength of a correlation between a non-reference image Iₙ thus newly shot and the reference image Iₒ is evaluated, and thereby it is judged whether the non-reference image Iₙ is valid or invalid. At the time when the non-reference image Iₙ is judged as valid, the non-reference image Iₙ is set as a new reference image Iₒ, and setting is then updated. Thereafter, the strength of a correlation between this newly set reference image Iₒ and a newly shot non-reference image Iₙ is evaluated.

For example, at the time when a separately-exposed image of the second shot is judged as invalid and then a separately exposed image of the third shot is judged as valid in the state where a separately-exposed image of the first shot is set as a reference image Iₒ, the reference image I_{c} is changed from the separately-exposed image of the first shot to that of the third shot. Subsequently, the strength of a correlation between the reference image Iₒ, which is the separately-exposed image of the third shot, and a non-reference image, which is the separately-exposed image of the fourth (or the fifth, . . . ) shot, is evaluated, thereby judging whether the non-reference image is valid or invalid. Following the above procedure, for each time a non-reference image is judged as valid, the reference image Iₒ is changed to the latest non-reference image which is judged as valid.

### Third Embodiment

Next, a third embodiment illustrates a method of evaluating the strength of correlation. The third embodiment is achieved in combination with the first and second embodiments.

As methods of evaluating the strength of correlation, first to fifteenth evaluation methods will be exemplified. In the description of each evaluation method, a method of calculating a correlation evaluation value will also be described.

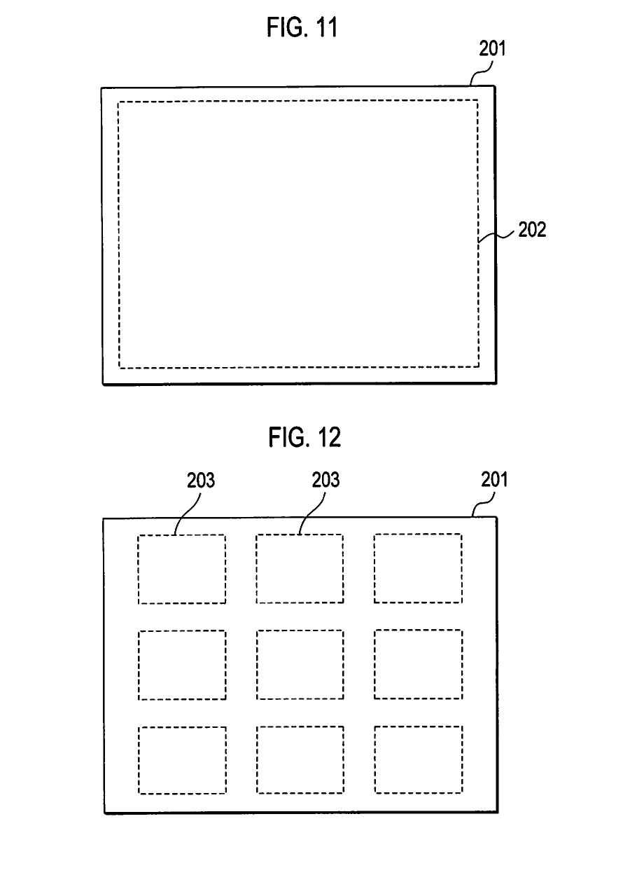

In the first, third, fifth, seventh, ninth, eleventh, and thirteenth evaluation methods, as shown in FIG. 11, one correlation evaluation region is defined within each separately-exposed image. In FIG. 11, reference numeral 201 designates one separately-exposed image, and reference numeral 202 designates one correlation evaluation region defined within the separately-exposed image 201. The correlation evaluation region 202 is, for example, defined as the entire region of the separately-exposed image 201. Incidentally, it is also possible to define, as the correlation evaluation region 202, a partial region within the separately-exposed image 201.

Meanwhile, in the second, fourth, sixth, eighth, tenth, twelfth, and fourteenth evaluation methods, as shown in FIG. 12, Q correlation evaluation regions are defined within each separately-exposed image. Here, Q is a positive integer, and is two or larger. In FIG. 12, reference numeral 201 designates a separately-exposed image, and a plurality of rectangular regions designated by reference numerals 203 represent the Q correlation evaluation regions defined within the separately-exposed image 201. FIG. 12 exemplifies the case where the separately-exposed image 201 is vertically trisected, and also horizontally trisected, so that Q is set to 9.

However, for the fifteenth evaluation method, a correlation evaluation region, such as those described above, is not defined.

For the sake of concreteness and clarity, in the description of the first to fourteenth evaluation methods, attention is paid to the non-reference image I₁ among (N−1) non-reference images Iₙ, and an evaluation of the strength of a correlation between the reference image Iₒ and the non-reference image I₁ will be described. As described above, when it is judged that a correlation between the reference image Iₒ and the non-reference image I₁ is comparatively weak, the non-reference image I₁ is judged as invalid, while when it is determined that a correlation therebetween is comparatively strong, the non-reference image I₁ is judged as valid. Similarly, judgment as to whether it is valid or not is performed on other non-reference images.

### [First Evaluation Method: Luminance Mean]

First, the first evaluation method will be described. In the first evaluation method, as described above, one correlation evaluation region is defined within each separately-exposed image. On each separately-exposed image, a mean value of luminance values of the respective picture elements within the correlation evaluation region is calculated, and this mean value is set as a correlation evaluation value.

The luminance value is the value of a luminance signal Y, which is generated in the image signal processing unit 13 by using an output signal of the AFE 12 of FIG. 1. For a target picture element within the separately-exposed image, a luminance value represents luminance of the target picture element, and the luminance of the target picture element increases as the luminance value increases.

When a correlation evaluation value of a reference image Iₒ is designated by C_{YO} and a correlation evaluation value of a non-reference image I₁ is designated by CY₁, the judging unit 43 judges whether or not the following equation (1) holds:

C_{YO}−C_{Y1}>TH₁ (1)

where TH₁ designates a predetermined threshold value.

When equation (1) holds, the degree of similarity between an image within a correlation evaluation region on Iₒ and an image within a correlation evaluation region on I₁ is comparatively low, so that the judging unit 43 determines that a correlation between Iₒ and I₁ is comparatively weak. Meanwhile, when equation (1) does not hold, the degree of similarity between an image within a correlation evaluation region on Iₒ and an image within a correlation evaluation region on I₁ is comparatively high, so that the judging unit 43 determines that a correlation between Iₒ and I₁ is comparatively strong. The judging unit 43 judges that the smaller the value on the left side of equation (1), the stronger the correlation between Iₒ and I₁ is.

### [Second Evaluation Method: Luminance Mean]

Next, a second evaluation method will be described. The second evaluation method is similar to the first evaluation method. In the second evaluation method, Q correlation evaluation regions are defined within each separately-exposed image as described above. Further, on each separately-exposed image, a correlation evaluation value is calculated for each correlation evaluation region by using a similar method as the first evaluation method (i.e., for each correlation evaluation region, a mean value of luminance values of the respective picture elements within each correlation evaluation region is calculated, and this mean value is set as a correlation evaluation value). Accordingly, for one separately exposed image, Q correlation evaluation values are calculated.

By using a similar method as the first evaluation method, for each correlation evaluation region, the judging unit 43 judges whether the degree of similarity between an image within the correlation evaluation region on Iₒ and an image within the correlation evaluation region on I₁ is comparatively high or low.

Further, by using the following “evaluation method α,” a correlation between Iₒ and I₁ is evaluated. In the evaluation method α, when the degree of similarity on p_{A} correlation evaluation regions or more (p_{A} is a predetermined integer of one or larger) is judged as comparatively low, it is then determined that a correlation between Iₒ and I₁ is comparatively weak, otherwise it is determined that a correlation between Iₒ and I₁ is comparatively strong.

### [Third Evaluation Method: Signal Mean for Each Color Filter]

Next, a third evaluation method will be described. The third and fourth evaluation methods assume the case that the imaging element 33 of FIG. 2 is formed of a single imaging element by using color filters of a plurality of colors. Such an imaging element is usually referred to as a single-plate-type imaging element.

For example, a red filter, a green filter, and a blue filter (not shown) are prepared, the red filter transmitting red light, the green filter transmitting green light, and the blue filter transmitting blue light. In front of each light receiving picture element of the imaging element 33, any one of the red filter, the green filter, and the blue filter is disposed. The way of disposing is, for example, Bayer arrangement. An output signal of a light receiving picture element corresponding to the red filter, an output signal of a light receiving picture element corresponding to the green filter, and an output signal of a light receiving picture element corresponding to the blue filter are respectively referred to as a red filter signal value, a green filter signal value, and a blue filter signal value. In practice, a red filter signal value, a green filter signal value, and a blue filter signal value are each represented by a value of a digital output signal from the AFE 12 of FIG. 1.

In the third evaluation method, as described above, one correlation evaluation region is defined within each separately-exposed image. On the each separately-exposed image, a mean value of red filter signal values, a mean value of green filter signal values, and a mean value of blue filter signal values within a correlation evaluation region are calculated as a red filter evaluation value, a green filter evaluation value, and a blue filter evaluation value, respectively. By using the red filter evaluation value, the green filter evaluation value, and the blue filter evaluation value, a correlation evaluation value is formed.

When a red filter evaluation value, a green filter evaluation value, and a blue filter evaluation value with respect to a reference image Iₒ are respectively designated by C_{RFO}, C_{GFO}, and C_{BFO}, and further, when a red filter evaluation value, a green filter evaluation value, and a blue filter evaluation value with respect to a non-reference image I₁ are respectively designated by C_{RF1}, C_{GF1}, and C_{BF1}, the judging unit 43 judges whether the following equations (2R), (2G), and (2B) hold:

C_{RFO}−C_{RF1}>TH_{2R} (2R)

C_{GFO}−C_{GF1}>TH_{2G} (2G)

C_{BFO}−C_{BF1}>TH_{2B} (2B)

where TH_{2R}, TH_{2G}, and TH_{2B} designate predetermined threshold values, and these values may or may not agree with each other.

When a predetermined number (one, two, or three) of equations hold among equations (2R), (2G), and (2B), the judging unit 43 determines that the degree of similarity between an image within a correlation evaluation region on Iₒ and an image within a correlation evaluation region on I₁ is comparatively low, and hence that the correlation between Iₒ and I₁ is comparatively weak. Meanwhile, when no equation holds, the judging unit 43 determines that the degree of similarity between an image within a correlation evaluation region on Iₒ and an image within a correlation evaluation region on I₁ is comparatively high, and hence that the correlation between Iₒ and I₁ is comparatively strong.

Incidentally, although the case where color filters of three colors, red, green, and blue, are provided has been exemplified, this is an exemplification to make the description more specific, and the colors of color filters and the kinds of colors thereof can be changed as needed.

### [Fourth Evaluation Method: Signal Mean for Each Color Filter]

Next, a fourth evaluation method will be described. The fourth evaluation method is similar to the third evaluation method. In the fourth evaluation method, Q correlation evaluation regions are defined within each separately-exposed image as described above. Further, on each separately-exposed image, a correlation evaluation value consisting of a red filter signal value, a green filter signal value, and a blue filter signal value is calculated for each correlation evaluation region by using a similar method as the third evaluation method.

The judging unit 43 judges, for each correlation evaluation region, whether the degree of similarity between an image within a correlation evaluation region on Iₒ and an image within a correlation evaluation region on I₁ is comparatively high or low, by using a similar method as the third evaluation method. Further, by using the above-described evaluation method α (refer to the second evaluation method), the judging unit 43 determines the strength of a correlation between Iₒ and I₁.

### [Fifth Evaluation Method: KGB Signal Mean]

Next, a fifth evaluation method will be described. In the fifth evaluation method, correlation evaluation values are calculated by using an RGB signal, and the strength of a correlation is evaluated according to the calculated values. When adopting the fifth evaluation method, the image signal processing unit 13 (or the image stabilization processing unit 40 of FIG. 3) of FIG. 1 generates, by using an output signal from the AFE 12, an R signal, a G signal, and a B signal, which are color signals, as image signals of each separately-exposed image.

In the fifth evaluation method, one correlation evaluation region is defined within each separately-exposed image as described above. For each separately-exposed image, a mean value of R signals, a mean value of G signals, and a mean value of B signals within a correlation evaluation region are respectively calculated as an R signal evaluation value, a G signal evaluation value, and a B signal evaluation value. By using the R signal evaluation value, the G signal evaluation value, and the B signal evaluation value, a correlation evaluation value is formed.

An R signal value, a G signal value, and a B signal value are respectively the value of an R signal, the value of G signal, and the value of a B signal. On a target picture element within a separately-exposed image, an R signal value, a G signal value, and a B signal value respectively represent the intensities of a red component, a green component, and a blue component of the target picture element. As the R signal value increases, the red component of the target picture element increases. The same applies to the G signal value and the B signal value.

Now, when an R signal evaluation value, a G signal evaluation value, and a B signal evaluation value with respect to a reference image Iₒ are respectively designated by C_{RO}, C_{GO}, and C_{BO}, and further, when an R signal evaluation value, a G signal evaluation value, and a B signal evaluation value with respect to a non-reference image I₁ are respectively designated by C_{R1}, C_{G1}, and C_{B1}, the judging unit 43 judges whether the following equations (3R), (3G), and (3B) hold:

C_{RO}−C_{R1}>TH_{3R} (3R)

C_{GO}−C_{G1}>TH_{3G} (3G)

C_{BO}−C_{B1}>TH_{3B} (3B)

where TH_{3R}, TH_{3G}, and TH_{3B} designate predetermined threshold values, and these values may or may not agree with each other.

When a predetermined number (one, two or three) of equations hold among equations (3R), (3G), and (3B), the judging unit 43 determines that the degree of similarity between an image within a correlation evaluation region on Iₒ and an image within a correlation evaluation region on I₁ is comparatively low, and hence that the correlation between Iₒ and I₁ is comparatively weak. Meanwhile, when no equation holds, the judging unit 43 determines that the degree of similarity between an image within a correlation evaluation region on Iₒ and an image within a correlation evaluation region on I₁ is comparatively high, and hence that the correlation between Iₒ and I₁ is comparatively strong.

### [Sixth Evaluation Method: RGB Signal Mean]

Next, a sixth evaluation method will be described. The sixth evaluation method is similar to the fifth evaluation method. In the sixth evaluation method, Q correlation evaluation regions are defined within each separately-exposed image as described above. Further, on each separately-exposed image, a correlation evaluation value consisting of an R signal evaluation value, a G signal evaluation value, and a B signal evaluation value is calculated for each correlation evaluation region, by using the same method as the fifth evaluation method.

The judging unit 43 judges, for each correlation evaluation region, whether the degree of similarity between an image within a correlation evaluation region on Iₒ and an image within a correlation evaluation region on I₁ is comparatively high or low, by using the same method as the fifth evaluation method. Further, by using the above-described evaluation method α (refer to the second evaluation method), the judging unit 43 determines the strength of a correlation between Iₒ and I₁.

### [Seventh Evaluation Method: Luminance Histogram]

Next, a seventh evaluation method will be described. In the seventh evaluation method, one correlation evaluation region is defined within each separately-exposed image as described above. Further, on each separately-exposed image, a histogram of luminance of each picture element within a correlation evaluation region is generated. Here, for the sake of making description concrete, luminance is represented by 8 bits, and assumes to take digital values in a range of 0 to 255.

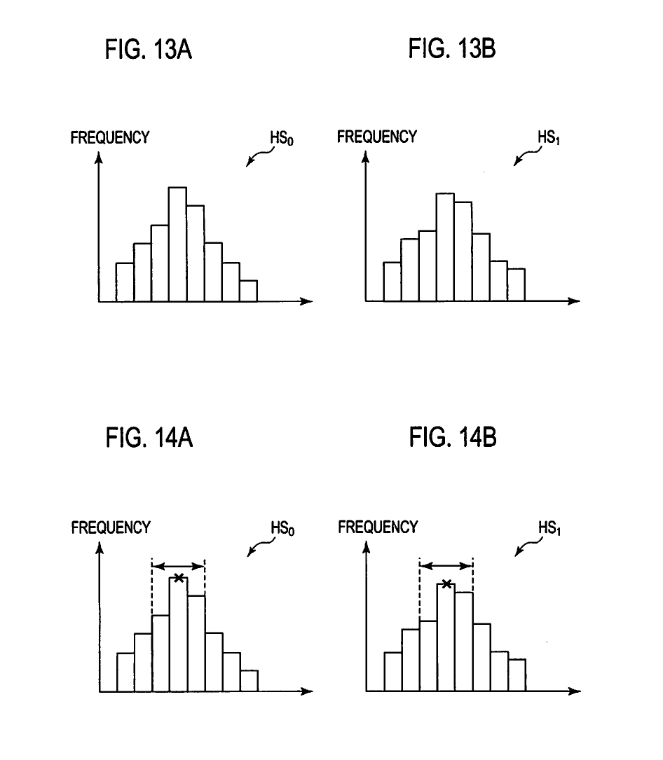

FIG. 13A is a view showing a histogram HSₒ with respect to a reference image Iₒ. A luminance value for each picture element within a correlation evaluation region on a reference image Iₒ is classified in a plurality of steps, whereby a histogram HSₒ is formed. FIG. 13B shows a histogram HS₁ with respect to a non-reference image I₁. As in the histogram HS_{c}, the histogram HS₁ is also formed by classifying a luminance value for each picture element within a correlation evaluation region on a non-reference image I₁ in a plurality of steps.

The number of steps for classification is selected from a range of 2 to 256. For example, assume the case where a luminance value is divided into 26 blocks each having 10 values for classification. In this case, for example, the luminance values “0 to 9” belong to the first classification step, the luminance values “10 to 19” belong to the second classification step, . . . , the luminance values “240 to 249” belong to the twenty-fifth classification step, and the luminance values “250 to 255” belong to the twenty-sixth classification step.

Each frequency of the first to twenty-sixth steps representing the histogram HSₒ forms a correlation evaluation value on a reference image Iₒ, and each frequency of the first to twenty-sixth steps representing the histogram HS₁ forms a correlation evaluation value on a non-reference image I₁.

For each classification step of the first to twenty-sixth steps, the judging unit 43 calculates a difference value between a frequency on the histogram HSₒ and a frequency on the histogram HS₁, and then compares the difference value thus calculated with a predetermined difference threshold value. For example, a difference value between a frequency of the first classification step of the histogram HSₒ and a frequency of the first classification step of the histogram HS₁ is compared with the above-described difference threshold value. Incidentally, the difference threshold value may take the same values or different values on different classification steps.

In addition, with respect to p_{B} (p_{B} is a predetermined positive integer such that 1≦p_{B}≦26) or more classification steps, when the difference value is larger than a difference threshold value, it is determined that the degree of similarity between an image within a correlation evaluation region on Iₒ and an image within a correlation evaluation region on I₁ is comparatively low, and hence that the correlation between Iₒ and I₁ is comparatively weak. Otherwise, it is determined that the degree of similarity between an image within a correlation evaluation region on Iₒ and an image within a correlation evaluation region on I₁ is comparatively high, and hence that the correlation between I₀ and I₁ is comparatively strong.

The above-described processing may also be performed as follows (this process is referred to as a varied frequency processing). FIGS. 14A and 14B will be referred. In the varied frequency processing, as shown in FIG. 14A, a classification step at which the frequency takes a largest value is identified in a histogram HSₒ, and frequencies Aₒ of luminance values are counted within a predetermined range with reference to a center value of the classification. Meanwhile, as shown in FIG. 14B, frequencies A₁ of luminance values within the same range are counted also in a histogram HS₁. For example, in the histogram HSₒ, when a classification step at which the frequency takes a largest value is the tenth classification step, the total of frequencies of the ninth to eleventh classification steps of the histogram HSₒ is set to Aₒ, while the total of frequencies of the ninth to eleventh classification steps of the histogram HS₁ is set to A₁.

When (Aₒ−A₁) is larger than a predetermined threshold value TH₄, it is determined that the degree of similarity between an image within a correlation evaluation region on Iₒ and an image within a correlation evaluation region on I₁ is comparatively low, and hence that the correlation between Iₒ and I₁ is comparatively weak. Otherwise, it is determined that the degree of similarity between an image within a correlation evaluation region on Iₒ and an image within a correlation evaluation region on I₁ is comparatively high, and hence that the correlation between Iₒ and I₁ is comparatively strong.

### [Eighth Evaluation Method: Luminance Histogram]

Next, an eighth evaluation method will be described. The eighth evaluation method is similar to the seventh evaluation method. In the eighth evaluation method, Q correlation evaluation regions are defined within each separately-exposed image as described above. Further, on each separately-exposed image, a correlation evaluation value corresponding to a histogram of luminance is calculated for every correlation evaluation region by using the same method as the seventh evaluation method.

By using the same method as the seventh evaluation method, the judging unit 43 judges, for each correlation evaluation region, whether the degree of similarity between an image within a correlation evaluation region on Iₒ and an image within a correlation evaluation region on I₁ is comparatively high or low. Further, the judging unit 43 determines the strength of a correlation between Iₒ and I₁ by using the above-described evaluation method α (refer to the second evaluation method).

### [Ninth Evaluation Method: Color Filter Signal Histogram]

Next, a ninth evaluation method will be described. As in the third evaluation method, the ninth evaluation method and a tenth evaluation method to be described later assume that the imaging element 33 of FIG. 2 is formed of a single imaging element. In the description of the ninth evaluation method, the same terms as those used in the third evaluation method will be used. In the ninth evaluation method, one correlation evaluation region is defined within each separately-exposed image as described above.

Further, for each color of a color filter, a histogram is generated by using the same method as the seventh method. More specifically, on each separately-exposed image, a histogram of a red filter signal value, a histogram of a green filter signal value, and a histogram of a blue filter signal value within a correlation evaluation region are generated.

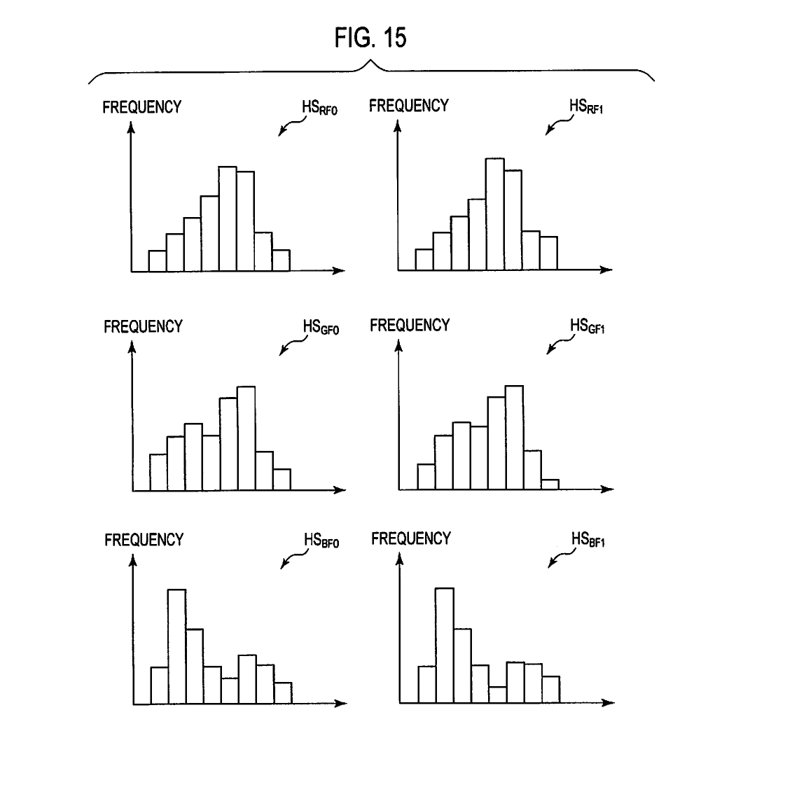

Now, a histogram of a red filter signal value, a histogram of a green filter signal value, and a histogram of a blue filter signal value with respect to a reference image Iₒ are respectively designated by HS_{RFO}, HS_{GFO}, and HS_{BFO}, and further, a histogram of a red filter signal value, a histogram of a green filter signal value, and a histogram of a blue filter signal value with respect to a non-reference image I₁ are respectively designated by HS_{RF1}, HS_{GF1}, and HS_{BF1}. FIG. 15 is a view showing states of these histograms. As in the specific example of the seventh evaluation method, each histogram is assumed to be divided into the first to twenty-sixth classification steps.

The respective frequencies representing the histograms HS_{RFO}, HS_{GFO}, and HS_{BFO} form a correlation evaluation value with respect to a reference image Iₒ, while the respective frequencies representing the histograms HS_{RF1}, HS_{GF1}, and HS_{BF1} form a correlation evaluation value with respect to a non-reference image I₁.

For every classification step of the first to twenty-sixth steps, the judging unit 43 calculates a difference value DIF_{RF} between a frequency on the histogram HS_{RFO} and a frequency on the histogram HS_{RF1}, and then compares the difference value DIF_{RF} With a predetermined difference threshold value TH_{RF}. For example, a difference value between a frequency of the first classification step of the histogram HS_{RFO} and a frequency of the first classification step of the histogram HS_{RF1} is compared with the above-described difference threshold value TH_{RF}. Incidentally, the difference threshold value TH_{RF} may take the same values or different values on different classification steps.

In the same manner, for each classification step of the first to twenty-sixth steps, the judging unit 43 calculates a difference value DIF_{GF} between a frequency on the histogram HS_{GFO} and a frequency on the histogram HS_{GF1}, and then compares the difference value DIF_{GF} with a predetermined difference threshold value TH_{GF}. Incidentally, the difference threshold value TH_{GF} may take the same values or different values on different classification steps.

In the same manner, for every classification step of the first to twenty-sixth steps, the judging unit 43 calculates a difference value DIF_{BF} between a frequency on the histogram HS_{BFO} and a frequency on the histogram HS_{BF1}, and then compares the difference value DIF_{BF} with a predetermined difference threshold value TH_{BF}. Incidentally, the difference threshold value TH_{BF} may take the same values or different values on different classification steps.

In addition, in the first to fourth histogram conditions, when a predetermine number (the predetermined number is one or larger) or more of conditions are satisfied, for example, it is determined that the degree of similarity between an image within a correlation evaluation region of Iₒ and an image within a correlation evaluation region of I₁ is comparatively low, and thus that the correlation between Iₒ and I₁ is comparatively weak. Otherwise, it is determined that the degree of similarity between an image within a correlation evaluation region of Iₒ and an image within a correlation evaluation region of I₁ is comparatively high, and hence that a correlation between Iₒ and I₁ is comparatively strong.

The first histogram condition is that “with respect to p_{CR} (p_{CR} is a positive integer such that 1≦p_{CR}≦26) or more classification steps, the difference value DIF_{RF} is larger than the difference threshold value TH_{RF}.” The second histogram condition is that “with respect to p_{CG} (p_{CG} is a positive integer such that 1≦p_{CG}≦26) or more classification steps, the difference value DIF_{GF} is larger than the difference threshold value TH_{GF}.” The third histogram condition is that “with respect to p_{CB} (p_{CB} is a positive integer such that 1≦p_{CB}≦26) or more classification steps, the difference value DIF_{BF} is larger than the difference threshold value TH_{BF}.” The fourth histogram condition is that “there exist a predetermined number of classification steps or more, the steps satisfying DIF_{RF}>TH_{RF}, DIF_{GF}>TH_{GF} and DIF_{BF}>TH_{BF}.”

Further, the varied frequency processing (refer to FIG. 14) described in the seventh evaluation method may be applied for each color of a color filter. For example, in the histogram HS_{RFO}, a classification step at which the frequency takes a largest value is identified, and frequencies A_{RFO} of luminance values are counted within a predetermined range with respect to a center value of the classification step. Meanwhile, also for the histogram HS₁, frequencies A_{RF1} of luminance values within the same range are counted. In the same manner, in the histogram HS_{GFO}, a classification step at which the frequency takes a largest value is identified, and frequencies A_{GFO} of luminance values are counted within a predetermined range with respect to a center value of the classification step. Meanwhile, also for the histogram HS₁, frequencies A_{GF1} of luminance values within the same range are counted. In the same manner, in the histogram HS_{BFO}, a classification step at which the frequency takes a largest value is identified, and frequencies A_{BFO} of luminance values are counted within a predetermined range with respect to a center value of the classification step. Meanwhile, also for the histogram HS₁, frequencies A_{BF1} of luminance values within the same range are counted.

Now, among the inequalities: (A_{RFO}−A_{RF1})>TH_{5R}; (A_{GFO}−A_{GF1})>TH_{5G}; and (A_{BFO}−A_{BF1})>TH_{5B}, when one, two, or three of the inequalities hold, it is determined that the degree of similarity between an image within a correlation evaluation region of Iₒ and an image within a correlation evaluation region of I₁ is comparatively low, and hence that the correlation between Iₒ and I₁ is comparatively weak. Otherwise, it is determined that the degree of similarity between an image within a correlation evaluation region of Iₒ and an image within a correlation evaluation region of I₁ is comparatively high, and hence that the correlation between Iₒ and I₁ is comparatively strong. Incidentally, TH_{5R}, TH_{5G}, and TH_{5B} designate predetermined threshold values, and there values may or may not agree with each other.

### [Tenth Evaluation Method: Color Filter Signal Histogram]

Next, a tenth evaluation method will be described. The tenth evaluation method is similar to the ninth evaluation method. In the tenth evaluation method, Q correlation evaluation regions are defined within each separately-exposed image as described above. Further, on each separately-exposed image, a correlation evaluation value corresponding to a histogram for each color of a color filter is calculated, for each correlation evaluation region, by using a similar method as the ninth evaluation method.

The judging unit 43 judges, for each correlation evaluation region, whether the degree of similarity between an image within a correlation evaluation region of Iₒ and an image within a correlation evaluation region of I₁ is comparatively high or low, by using a similar method as the ninth evaluation method. Further, the judging unit 43 determines the strength of a correlation between Iₒ and I₁ by using the above-described evaluation method α (refer to the second evaluation method).

### [Eleventh Evaluation Method: RGB Signal Histogram]

Next, an eleventh evaluation method will be described. In the eleventh evaluation method, histograms on RGB signals are generated. Further, in the eleventh evaluation method, one correlation evaluation region is defined within each separately-exposed image as described above.

For each one of R, G, and B signals, a histogram is generated by using a similar method as the seventh method. More specifically, on each separately-exposed image, a histogram of an R signal value, a histogram of a G signal value, and a histogram of a B signal value within a correlation evaluation region are generated.

Here, a histogram of an R signal value, a histogram of a G signal value, and a histogram of a B signal value with respect to a reference image Iₒ are respectively designated by HS_{RO}, HS_{GO}, and HS_{BO}, and further, a histogram of an R signal value, a histogram of a G signal value, and a histogram of a B signal value with respect to a non-reference image I₁ are respectively designated by HS_{R1}, HS_{G1}, and HS_{B1}.

The respective frequencies representing the histograms HS_{RO}, HS_{GO}, and HS_{BO} form a correlation evaluation value with respect to the reference image Iₒ, while the respective frequencies representing the histograms HS_{R1}, HS_{G1}, and HS_{B1} form a correlation evaluation value with respect to the non-reference image I₁.

In the ninth evaluation method, a histogram is generated for each one of the colors, red, green, and blue, of color filters, and, the strength of a correlation is evaluated according to the histograms. On the other hand, in the eleventh evaluation method, a histogram is generated for each one of the R, G, and B signals, and the strength of a correlation is evaluated according to the histograms. In the ninth and eleventh evaluation methods, the evaluation methods for the strength of correlation are the same, and thus, the description thereof is omitted. In the case of adopting the eleventh evaluation method, it is only necessary to replace the histograms HS_{RFO}, HS_{GFO}, HS_{BFO}, HS_{RF1}, HS_{GF1}, and HS_{BF1} of the ninth evaluation method with HS_{RO}, HS_{GO}, HS_{BO}, HS_{R1}, HS_{G1}, and HS_{B1}, respectively.

### [Twelfth Evaluation Method: RGB Signal Histogram]

Next, a twelfth evaluation method will be described. The twelfth evaluation method is similar to the eleventh evaluation method. In the twelfth evaluation method, Q correlation evaluation regions are defined within each separately-exposed image as described above. Further, on each separately-exposed image, a correlation evaluation value corresponding to a histogram for each one of R, G, and B signals is calculated, for every correlation evaluation region, by using a similar method as the eleventh evaluation method.

The judging unit 43 judges, for each correlation evaluation region, whether the degree of similarity between an image within a correlation evaluation region of Iₒ and an image within a correlation evaluation region of I₁ is comparatively high or low, by using a similar method as the eleventh evaluation method. Further, the judging unit 43 determines the strength of a correlation between Iₒ and I₁, by using the above-described evaluation method α (refer to the second evaluation method).

### [Thirteenth Evaluation Method: High Frequency Component of Image]

Next, a thirteenth evaluation method will be described. In the thirteenth evaluation method, one correlation evaluation region is defined within each separately-exposed image as described above. Further, for each separately-exposed image, a high frequency component within a correlation evaluation region is calculated, and the integrated high frequency component is then set to be a correlation evaluation value.

A specific example will be described below. Each picture element within a correlation evaluation region of a reference image Iₒ is considered as a target picture element. When a luminance value of the target picture element is designated by Y(x, y), and when a luminance value of a picture element contiguous to the target picture element in the right hand side direction thereof is designated by Y(x+1, y), “Y(x, y)−Y(x+1, y)” is calculated as an edge component. This edge component is calculated by considering each picture element within the correlation evaluation region of the reference image Iₒ as a target picture element, and an integrated value of the edge component calculated with respect to each target picture element is set as a correlation evaluation value of the reference image Iₒ. Similarly, a correlation evaluation value is calculated also for a non-reference image I₁.

The judging unit 43 compares, with a predetermined threshold value, a difference value between a correlation evaluation value on the reference image Iₒ, and a correlation evaluation value on the non-reference image I₁, and determines, when the former is larger than the latter, that the degree of similarity between an image within a correlation evaluation region of Iₒ and an image within a correlation evaluation region of I₁ is comparatively low, and hence that the correlation between Iₒ and I₁ is comparatively weak. Meanwhile, when the former is smaller than the latter, the judging unit 43 determines that the degree of similarity between an image within a correlation evaluation region of Iₒ and an image within a correlation evaluation region of I₁ is comparatively high, and hence that a correlation between Iₒ and I₁ is comparatively strong.

In the above-described example, an edge component in a vertical direction is calculated as a high frequency component by using an operator having a size of 2×1, and a correlation evaluation value is calculated by using the high frequency component. However, by using another arbitrary method, it is possible to calculate a high frequency component which can be a basis for calculating a correlation evaluation value. For example, by using an operator having an arbitrary size, an edge component in a horizontal direction, a vertical direction, or an oblique direction may be calculated as a high frequency component, or a high frequency component may also be calculated by using the Fourier transform.

### [Fourteenth Evaluation Method: High Frequency Component of Image]

Next, a fourteenth evaluation method will be described. The fourteenth evaluation method is similar to the thirteenth evaluation method. In the fourteenth evaluation method, Q correlation evaluation regions are defined within each separately-exposed image as described above. Further, on each separately-exposed image, a correlation evaluation value based on a high frequency component is calculated for every correlation evaluation region by using a similar method as the thirteenth evaluation method.

The judging unit 43 judges, for each correlation evaluation region, whether the degree of similarity between an image within a correlation evaluation region of Iₒ and an image within a correlation evaluation region of I₁ is comparatively high or low, by using a similar method as the thirteenth evaluation method. Further, the judging unit 43 determines the strength of a correlation between Iₒ and I₁ by using the above-described evaluation method α (refer to the second evaluation method).

### [Fifteenth Evaluation Method: Motion Vector]

Next, a fifteenth evaluation method will be described. The fifteenth evaluation method is also used in combination with the first processing procedure of the first embodiment, or with the second processing procedure of the second embodiment. However, in the case of adopting the fifteenth evaluation method, a correlation evaluation value does not exist for a reference image Iₒ. Accordingly, for example, when the operation procedure of FIG. 6 is applied to the fifteenth evaluation method, the processing of Step S6 is eliminated, and, along with this elimination, contents of Steps S4 to S10 are appropriately changed. A method of judging whether each non-reference image is valid or invalid to be used in the case of adopting the fifteenth evaluation method will become apparent from the following description. Processing following the judging of whether each non-reference image is valid or invalid is similar to that described in the first or second embodiment.

In the fifteenth evaluation method, the function of the motion detecting unit 41 of FIG. 3 is used. As described above, the motion detecting unit 41 calculates a plurality of region motion vectors between two separately-exposed images under comparison.

As described above, exposure time T2 on each separately-exposed image is set so that an influence by camera shake within each separately-exposed image can be disregarded. Accordingly, motions of images within two separately-exposed images which are shot within a small time interval in the time-direction are small. Thus, usually, the magnitude of each motion vector between two separately-exposed images is comparatively small. To put it another way, when the magnitude of the vector is comparatively large, it means that one (or both) of the two separately-exposed images is not suitable for an image for synthesis. The fifteenth evaluation method is based on this aspect.

A specific example will be described. Here, assume that a separately-exposed image of a first shot is a reference image Iₒ. A plurality of region motion vectors between separately-exposed images shot at the first and second are calculated, and the magnitude of each of the plurality of region motion vectors is compared with a threshold value. When a predetermined number or more of the magnitudes of region motion vectors are larger than the threshold value, the judging unit 43 determines that a correlation between the separately-exposed image (reference image Iₒ) of the first shot and the separately-exposed image (non-reference image) of the second shot is comparatively weak, and hence that the separately-exposed image (non-reference image) of the second shot is invalid. Otherwise, the judging unit 43 determines that the correlation therebetween is comparatively large, and hence that the separately-exposed image of the second shot is valid.

When it is determined that the separately-exposed image of the second shot is valid, a plurality of region motion vectors between separately-exposed images shot at the second and third are calculated, and then, it is judged, by using a similar method as that described above, whether the separately-exposed image (non-reference image) of the third shot is valid or invalid. The same applies to separately-exposed images of subsequent shots.

When it is determined that the separately-exposed image of the second shot is invalid, a plurality of region motion vectors between separately-exposed images shot at the first and third are calculated, and then, the magnitude of each of the plurality of region motion vectors is compared with a threshold value. When a predetermined number or more of the magnitudes of region motion vectors are larger than the threshold value, the separately-exposed image (reference image I_{c}) of the third shot is also judged as invalid. The same processing is performed on the separately-exposed images of the first and fourth shots (the same applies to a separately-exposed image of the fifth shot and a shot subsequent thereto). Otherwise, the separately-exposed image of the third shot is judged as valid. Thereafter, it is judged whether the separately-exposed image of the fourth shot is valid or invalid according to region motion vectors between the separately-exposed images of the third and fourth shots.

In the fifteenth evaluation method, it is possible to consider that the correlation-evaluation-value calculating unit 42 calculates a correlation evaluation value according to region motion vectors calculated by the motion detecting unit 41, and also that the correlation evaluation value represents, for example, the magnitude of the motion vector. According to the magnitude of the motion vector, the judging unit 43 estimates the strength of a correlation of each non-reference image with the reference image Iₒ, and then determines whether the each non-reference image is valid or invalid as described above. A non-reference image which is estimated to have a comparatively strong correlation with the reference image I_{c}, is judged as valid, while a non-reference image which is estimated to have a comparatively weak correlation with the reference image Iₒ is judged as invalid.

### Fourth Embodiment

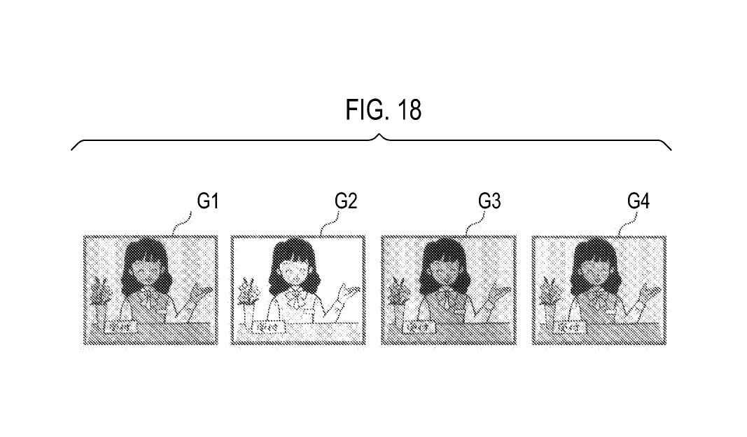

Incidentally, an example in FIG. 18 shows that, among a plurality of separately-exposed images serially captured to generate an image for synthesis, some influence due to an abrupt change in capturing circumstance has appeared on only one separately-exposed image. Such an influence may also appear on two or more separately-exposed images. Applications of the first processing procedure corresponding to FIG. 5 and the second processing procedure corresponding to FIG. 9 in connection with this influence is studied as a fourth embodiment. First to third examples of situations will be described below individually.

### FIRST SITUATIONAL EXAMPLE

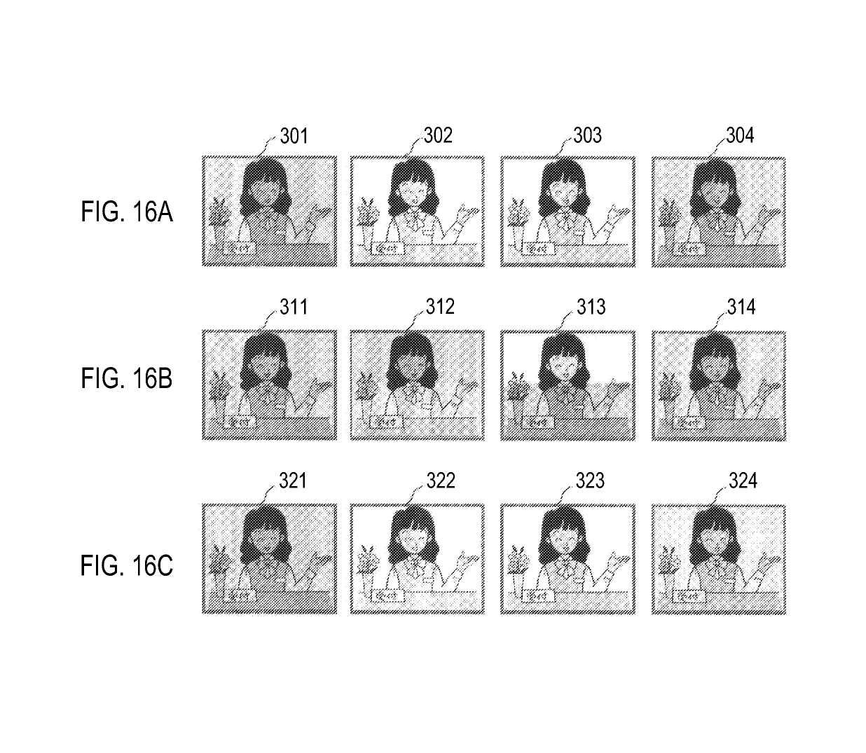

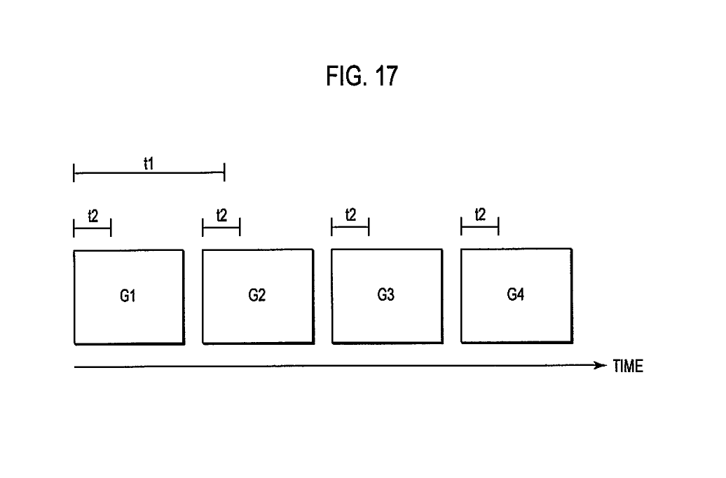

First, a first example of situation will be described. In the first example of situation, the imaging element 33 of FIG. 2 is assumed to be a CCD image sensor. FIG. 16A represents separately-exposed images 301, 302, 303, and 304, which are respectively captured at the first, second, third, and fourth time. Here, it is assumed that a flash is used by a surrounding camera at a timing close to that at which the separately-exposed image 302 is captured.

In the case where the imaging element 33 is a CCD image sensor, when an influence by a flash exerts on a plurality of frames, for example, the entire separately-exposed images 302 and 303 are extremely brighter than the separately-exposed image 301 and the like as shown in FIG. 16A. In the case of intending to satisfy the inequality “(P_{NUM}+1)≧M” in Step S11 of FIG. 6 also in light of the occurrence of such a situation, it is necessary to increase a storage capacity of the image memory 50 (refer to FIG. 5). For this reason, it is preferable to adopt the second processing procedure corresponding to FIG. 9 in order not to increase the storage capacity of the image memory 50.

### SECOND SITUATIONAL EXAMPLE

Next, a second situational example will be described. In the second situational example, the imaging element 33 of FIG. 2 is assumed to be a CMOS image sensor for capturing an image by using a rolling shutter. FIG. 16B represents separately-exposed images 311, 312, 313, and 314 which are respectively captured at the first, second, third, and fourth time by using this CMOS image sensor. The second separately-exposed image 312 assumes that a flash is used by a surrounding camera at a timing close to that at which the separately-exposed image 312 is captured.

When an image is captured by using a rolling shutter, exposure timings are different between different horizontal lines. Thus, depending on a start timing and an end timing of flashing by another camera, a separately-exposed image in an upper part and a lower part of which are different in brightness is obtained in some cases, as in the separately-exposed images 312 and 313.

In such a case, when there is only one correlation evaluation region within each separately-exposed image (for example, when the first evaluation method is adopted), differences of signal values (luminance and the like) in upper and lower parts of an image are averaged, and thus, the strength of correlation may not be evaluated appropriately. Accordingly, in the case of using the CMOS image sensor for capturing an image by using a rolling shutter, it is preferable to adopt an evaluation method (for example, the second evaluation method) in which a plurality of correlation evaluation regions are defined within each separately-exposed image. A plurality of correlation evaluation regions are defined, and then, the degree of similarity between a reference image and a non-reference image is evaluated for each correlation evaluation region, whereby a difference on upper and lower parts of the image can be reflected on the judgment on whether a non-reference image is valid or invalid.

### THIRD SITUATIONAL EXAMPLE

Further, as shown in FIG. 16C, there are some cases where a plurality of frames are influenced by a flash by another camera while the degree of brightness of the flash gradually decreases (this situation is referred to as a third situational example). In the third situational example, FIG. 16C represents separately exposed images 321, 322, 323, and 324 which are respectively captured at the first, second, third, and fourth time. Here, it is assumed that a flash is used by a surrounding camera at a timing close to that at which the separately-exposed image 322 is captured. Incidentally, in the third situational example, the imaging element 33 may be any one of a CCD image sensor and a CMOS image sensor.

In the case of intending to satisfy the inequality “(P_{NUM}+1)≧M” in Step S11 of FIG. 6 also in light of the occurrence of such a situation, it is necessary to increase a storage capacity of the image memory 50 (refer to FIG. 5). Because of this, it is preferable to adopt the second processing procedure corresponding to FIG. 9 in order not to increase the storage capacity of the image memory 50.

### (Variations)

As variations or comments for the above-described embodiments, Comments 1 to 3 will be described below. Contents described in each Comment can be arbitrarily combined unless inconsistency occurs.

### [Comment 1]

Specific values in the above description are merely for exemplification, and those values can be surely changed. A “mean” on a value can be replaced by “integrated” or “total” unless inconsistency occurs.

### [Comment 2]

Further, the imaging device 1 of FIG. 1 can be formed of hardware or in combination of hardware and software. Especially, a function of the image stabilization processing unit 40 of FIG. 3 (or a function of the above-described additive-type image stabilization processing) can be implemented by hardware or software, or in combination of hardware and software.

In the case of configuring the imaging device 1 by using software, a block diagram regarding a part which can be formed of software represents a functional block diagram of that part. The whole function or part of the function (or a function of the above-described additive-type image stabilization processing) of the image stabilization processing unit 40 of FIG. 3 may be described as a program, and thereby, the program may be executed by a program executing unit (for example, a computer), so that the whole function or part of the function can be implemented.

### [Comment 3]

In the above-described embodiments, the image stabilization processing unit 40 of FIG. 3 serves as a synthetic-image generating unit. In addition, the judging unit 43 of FIG. 3 serves as a correlation evaluating unit. It is also possible to consider that the correlation-evaluation-value calculating unit 42 is included in this correlation evaluating unit. Further, a part formed of the displacement correction unit 44 and the image synthesis calculating unit 45 serves as an image synthesizing unit.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An imaging device, comprising:
an imaging unit configured to sequentially capture a plurality of separately-exposed images; and
a synthetic-image generating unit configured to generate one synthetic image from the plurality of separately-exposed images, said synthetic-image generating unit comprising:
a correlation evaluating unit configured to judge whether or not each non-reference image is valid according to the strength of a correlation between a reference image and each of the non-reference images, wherein any one of the plurality of separately-exposed images is specified as the reference image while the other separately-exposed images are specified as non-reference images; and
an image synthesizing unit configured to generate the synthetic image by additively synthesizing at least two of the candidate images for synthesis including the reference image and the valid non-reference images.

2. The imaging device as claimed in claim 1, wherein, when the selected number of plurality of candidate images for synthesis is equal to or greater than a predetermined required number of images for addition, the image synthesizing unit employs, from among the plurality of candidate images for synthesis, the candidate images for synthesis of the required number of images for addition respectively as images for synthesis, and further performs additive synthesis on the images for synthesis to thereby generate the synthesis image.

3. The imaging device as claimed in claim 1, wherein, when the number of candidate images for synthesis is less than a predetermined required number of images for addition, the synthetic-image generating unit generates duplicate images of any one of the plurality of candidate images for synthesis so as to increase the total number of the plurality of candidate images and the duplicate images up to the required number of images for addition; and the image synthesizing unit respectively sets the plurality of candidate images and the duplicate images as images for synthesis, and generates the synthetic image by additively synthesizing the images for synthesis.

4. The imaging device as claimed in claim 1, wherein, when the number of candidate images for synthesis is less than a required number of images for addition, the image synthesizing unit performs a brightness correction on an image obtained by additively synthesizing the plurality of candidate images for synthesis, the brightness correction being performed according to a ratio between the number of candidate images for synthesis and the required number of images for addition.

5. The imaging device as claimed in claim 1, wherein the imaging unit serially captures separately-exposed images as the plurality of separately-exposed images in excess of a predetermined required number of images for addition in order to generate the synthetic image.

6. The imaging device as claimed in claim 1, wherein the number of separately-exposed images is variably set according to a determination of whether each of the non-reference images is valid or invalid so that the number of candidate images for synthesis attains a predetermined required number of images for addition.

7. The imaging device as claimed in claim 1, wherein the correlation evaluating unit calculates, for each separately-exposed image, an evaluation value based on a luminance signal, and evaluates the strength of the correlation by comparing the evaluation value for the reference image and the evaluation value for each of the non-reference images, thereby judging whether or not each of the non-reference images is valid according to the evaluation result.

8. The imaging device as claimed in claim 1, wherein the correlation evaluating unit calculates, for each separately-exposed image, an evaluation value based on a color signal, and evaluates the strength of the correlation by comparing the evaluation value for the reference image and the evaluation value for each of the non-reference images, thereby judging whether each of the non-reference images is valid or not according to the evaluation result.

9. The imaging device as claimed in claim 1,
wherein the imaging unit comprises:
an imaging element having a plurality of light-receiving picture elements; and
a plurality of color filters respectively allowing lights of specific colors to pass through,
each one of the plurality of light-receiving picture elements is provided with a color filter of any one of the colors, and the plurality of light-receiving picture elements output signals of each separately-exposed image,
the correlation evaluating unit calculates, for each of the separately-exposed images, an evaluation value based on the output signals of the light-receiving picture elements that are provided with the color filters of the same color, and evaluates the strength of the correlation by comparing the evaluation value for the reference image and the evaluation value for each of the non-reference images, thereby judging whether each of the non-reference images is valid according to the evaluation result.

10. The imaging device as claimed in claim 1, further comprising a motion vector calculating unit configured to calculate a motion vector representing motion of an image between the separately-exposed images according to output signals of the imaging unit,
wherein the correlation evaluating unit evaluates the strength of the correlation according to the motion vector, and then judges whether each of the non-reference images is valid according to the evaluation result.

11. The imaging device as claimed in claim 1, wherein the correlation evaluating unit calculates a correlation evaluation value for each of a plurality of correlation evaluation regions defined within each separately-exposed image.

12. The imaging device as claimed in claim 1, wherein the correlation evaluating unit evaluates, by using an R signal, a G signal, and a B signal, which respectively are color signals for each separately-exposed image, the strength of the correlation for each of the signals, and then judges whether each of the non-reference images is valid according to the evaluation result.

13. The imaging device as claimed in claim 1, wherein the correlation evaluating unit compares luminance histograms of the reference image and each of the non-reference images, calculates a difference value of each frequency, and compares the difference value with a predetermined threshold difference value, thereby judging whether each of the non-reference images is valid or not according to the evaluation result.

14. The imaging device as claimed in claim 1, wherein the correlation evaluating unit calculates high frequency components of the separately-exposed images, sets an integrated value of the calculated high frequency components as a correlation evaluation value, and compares the evaluation value for the reference image and the evaluation value for each of the non-reference images, thereby determining whether each of the non-reference images is valid or not according to the result evaluation.
